(19) United States
(12) Patent Application Publication
(10) Pub. No.: US 2025/0320154 A1
(43) Pub. Date: Oct. 16, 2025

(54) TREATED GLASS-BASED ARTICLES AND METHODS OF FORMING SAME

(71) Applicant: CORNING INCORPORATED, CORNING, NY (US)

(72) Inventors: Robert Randall Hancock, JR., Corning, NY (US); Bronson David Hausmann, Corning, NY (US); Yuhui Jin, Painted Post, NY (US); Cedrick Alexander O’Shaughnessy, Painted Post, NY (US); Meng Shang, Painted Post, NY (US); Nicholas Michael Stone-Weiss, Corning, NY (US); Ljerka Ukrainczyk, Ithaca, NY (US)

(21) Appl. No.: 19/176,732

(22) Filed: Apr. 11, 2025

Related U.S. Application Data
(60) Provisional application No. 63/634,788, filed on Apr. 16, 2024.

(51) Int. Cl. C03C 15/00; C03C 3/097; C09K 13/02

(52) U.S. Cl. CPC C03C 15/00; C03C 3/097; C09K 13/02

(57) ABSTRACT

A method of forming a treated glass-based article comprises: contacting an aluminosilicate glass-based article with an etchant, the etchant comprising: greater than or equal to 30 wt % and less than or equal to 100 wt % potassium hydroxide; and less than or equal to 10 wt % sodium hydroxide; and wherein a temperature of the etchant is greater than or equal to 130° C. during the contacting.

This application claims the benefit of priority under 35 U.S.C. § 119 of U.S. Provisional Application Ser. No. 63/634,788 filed on Apr. 16, 2024, the content of which is relied upon and incorporated herein by reference in its entirety.

### FIELD

The present specification generally relates to glass-based articles and, in particular, to methods of treating glass-based articles with etchants.

### TECHNICAL BACKGROUND

Materials are in demand for high strength substrates for portable electronic devices. Several materials are currently being utilized on the market such as glass, zirconia, plastic, metal, and glass-ceramics. Aluminosilicate glass-based articles have certain advantages over other materials, but it can be difficult to form an aluminosilicate glass-based article having certain desired properties required for a high strength portable device such as increased surface strength and decreased haze. Accordingly, a need exists for treated glass-based articles having improved properties and methods for forming the treated glass-based articles.

### SUMMARY

According to a first aspect A1, a method of forming a treated glass-based article, wherein the method may comprise: contacting an aluminosilicate glass-based article with an etchant, the etchant comprising: greater than or equal to 30 wt % and less than or equal to 100 wt % potassium hydroxide; and less than or equal to 10 wt % sodium hydroxide; and wherein a temperature of the etchant is greater than or equal to 130° C. during the contacting.

A second aspect A2 includes the method according to the first aspect A1, wherein the etchant further comprises greater than 0 wt. % and less than or equal to 70 wt % of a secondary salt, wherein the secondary salt does not comprise sodium.

A third aspect A3 includes the method according to the second aspect A2, wherein the secondary salt comprises potassium nitrate, potassium sulphate, potassium carbonate, potassium phosphate, calcium hydroxide, or combinations thereof.

A fourth aspect A4 includes the method according to any one of the first through third aspects A1-A3, wherein the etchant comprises less than or equal to 10 wt % sodium ions, less than or equal to 5 wt % sodium ions, or even less than or equal to 1 wt % sodium ions.

A fifth aspect A5 includes the method according to any one of the first through fourth aspects A1-A4, wherein the etchant comprises less than or equal to 15 wt. % water, less than or equal to 10 wt. % water, less than or equal to 5 wt. % water, or even than or equal to 1 wt. % water.

A sixth aspect A6 includes the method according to any one of the first through fifth aspects A1-A5, wherein a temperature of the etchant is greater than or equal to 150° C., greater than or equal to 175° C., greater than or equal to 200° C., or even greater than or equal to 225° C.

A seventh A7 includes the method according to any one of the first through sixth aspects A1-A6, wherein a temperature of the etchant is less than or equal to 300° C., less than or equal to 275° C., less than or equal to 250° C., less than or equal to 275° C., or less than or equal to 200° C.

An eighth aspect A8 includes the method according to any one of the first through seventh aspects A1-A7, the etchant comprises: greater than or equal to 30 wt % and less than or equal to 80 wt % potassium hydroxide; and greater than or equal to 20 wt % and less than or equal to 60 wt % of a secondary salt comprising potassium nitrate, potassium sulphate, potassium carbonate, potassium phosphate, or combinations thereof; a temperature of the etchant is greater than or equal 200° C. and less than or equal to 300° C.; and the contacting comprises submerging the aluminosilicate glass-based article in the etchant for a duration of time is greater than or equal to 5 minutes and less than or equal to 2 hours.

A ninth aspect A9 includes the method according to any one of the first through eighth aspects A1-A8, the etchant comprises: greater than or equal to 50 wt % and less than or equal to 70 wt % potassium hydroxide; greater than or equal to 30 wt % and less than or equal to 50 wt % of water; and a temperature of the etchant is greater than or equal 150° C. and less than or equal to 200° C.; and the contacting comprises submerging the aluminosilicate glass-based article in the etchant for a duration of time is greater than or equal to 5 minutes and less than or equal to 2 hours.

A tenth aspect A10 includes the method according to any one of the first through ninth aspects A1-A9, wherein the etchant comprises greater than or equal to 30 wt % potassium hydroxide, and greater than or equal to 0 wt % and less than or equal to 70 wt % of a secondary salt comprising potassium nitrate, potassium sulphate, potassium carbonate, potassium phosphate, or combinations thereof.

An eleventh aspect A11 includes the method according to any one of the first through tenth aspects A1-A10, wherein the etchant comprises greater than or equal to 50 wt % and less than or equal to 80 wt % potassium hydroxide, and greater than or equal to 20 wt % and less than or equal to 50 wt % of water.

A twelfth aspect A12 includes the method according to any one of the first through eleventh aspects A1-A11, wherein the aluminosilicate glass-based article has a thickness; and the contacting reduces the thickness by at least 1 μm, at least 3 μm, at least 5 μm, at least 10 μm, or even at least at least 20 μm at an average rate of greater than or equal to 1 μm per hour and less than or equal to 50 μm per hour.

A thirteenth aspect A13 includes the method according to any one of the first through twelfth aspects A1-A12, wherein the contacting comprises submerging the aluminosilicate glass-based article in the etchant for a duration of time.

A fourteenth aspect A14 includes the method according to any one of the first through thirteenth aspects A1-A13, wherein the duration of time is greater than or equal to 5 minutes and less than or equal to 10 hours.

A fifteenth aspect A15 includes the method according to any one of the first through fourteenth aspects A1-A14, wherein the treated glass-based article comprises a surface, and wherein a surface roughness (Sq) of the surface is less than or equal to 10 nm, less than or equal to 9 nm, less than or equal to 8 nm, less than or equal to 7 nm, less than or equal to 6 nm, or even less than or equal to 5 nm.

A sixteenth aspect A16 includes the method according to the fifteenth aspect A15, wherein the surface is a first major surface and the treated glass-based article comprises a second major surface, the first major surface opposite the second major surface, wherein at least a portion of the first major surface is textured.

A seventeenth aspect A17 includes the method according to the fifteenth aspect A15 or the sixteenth aspect A16, wherein an opacity of the treated glass-based article is greater than or equal to 0% and less than or equal to 30%.

An eighteenth aspect A18 includes the method according to the fifteenth aspect A15 or the sixteenth aspect A16, wherein an opacity of the treated glass-based article is greater than 30% and less than 80%.

A nineteenth aspect A19 includes the method according to the fifteenth aspect A15 or the sixteenth aspect A16, wherein an opacity of the treated glass-based article is greater than or equal to 80% and less than or equal to 100%.

A twentieth aspect A20 includes the method according to any one of the fifteenth through eighteenth aspects A15-A18, wherein a transmittance haze of the surface is less than or equal to 1%.

A twenty-first aspect A21 includes the method according to any one of the fifteenth through twentieth aspects A15-A20, wherein a gloss of the surface is greater than or equal to 80%.

A twenty-second aspect A22 includes the method according to any one of the first through twenty-first aspects A1-A21, wherein the aluminosilicate glass-based article comprises a surface, and wherein at least a portion of the surface is textured.

A twenty-third aspect A23 includes the method according to any one of the first through twenty-second aspects A1-A22, wherein the aluminosilicate glass-based article is ion-exchanged prior to the contacting.

A twenty-fourth aspect A24 includes the method according to any one of the first through twenty-third aspects A1-A23, wherein the treated glass-based article is ion-exchanged subsequent to the contacting.

A twenty-fifth aspect A25 includes the method according to any one of the first through twenty-fourth aspects A1-A24, wherein the aluminosilicate glass-based article comprises glass ceramic.

A twenty-sixth aspect A26 includes the method according to any one of the first through twenty-fifth aspects A1-A25, wherein the aluminosilicate glass-based article comprises: greater than or equal to 55 wt % and less than or equal to 80 wt % SiO₂; greater than or equal to 2 wt % and less than or equal to 12 wt % Al₂O₃; greater than or equal to 8 wt % and less than or equal to 17 wt % Li₂O; greater than or equal to 0.1 wt % and less than or equal to 5 wt % P₂O₅; greater than or equal to 2 wt % and less than or equal to 15 wt % ZrO₂; and greater than or equal to 0.05 wt % and less than or equal to 4 wt % CaO.

A twenty-seventh aspect A27 includes the method according to any one of the first through twenty-sixth aspects A1-A26, wherein the aluminosilicate glass-based article further comprises one or more of: greater than or equal to 0 wt % and less than or equal to 3 wt % MgO; greater than or equal to 0 wt % and less than or equal to 4 wt % ZnO; greater than or equal to 0 wt % and less than or equal to 5 wt % Na₂O; greater than or equal to 0 wt % and less than or equal to 3 wt % K₂O; and greater than or equal to 0 wt % and less than or equal to 2 wt % Fe₂O₃.

A twenty-eighth aspect A28 includes the method according to any one of the first through twenty-seventh aspects A1-A27, wherein the etchant is in a vessel during the contacting, and wherein the vessel comprises vessel walls, the vessel walls comprising greater than or equal to 50 wt. % nickel, based on the total weight of the of the vessel walls.

A twenty-ninth aspect A29 includes the method according to the twenty-eighth aspect A28, wherein the vessel walls comprise greater than or equal to 60 wt. % nickel, greater than or equal to 70 wt. % nickel, greater than or equal to 80 wt. % nickel, greater than or equal to 90 wt. % nickel, or greater than or equal to 95 wt. % nickel, based on the total weight of the of the vessel walls.

A thirtieth aspect A30 includes the method according to any one of the first through twenty-ninth aspects A1-A29, further comprising, after contacting the aluminosilicate glass-based article with the etchant, contacting the aluminosilicate glass-based article with an acid mixture, the acid mixture comprising from 1 wt % to 20 wt % of one or more acids.

A thirty-first aspect A31 includes the method according to the thirtieth aspect A30, wherein a temperature of the acid mixture during the contacting is greater than or equal to 30° C. and less than or equal to 80° C.

A thirty-second aspect A32 includes the method according to the thirtieth aspect A30 or the thirty-first aspect A31, wherein the acid mixture comprises citric acid, hydrochloric acid, nitric acid, sulfuric acid, or combinations thereof.

A thirty-third aspect A33 includes the method according to any one of the first through thirty-second aspects A1-A32, wherein contacting the aluminosilicate glass-based article with an acid mixture comprises submerging the aluminosilicate glass-based article in the acid mixture for a duration of greater than or equal to 1 minute and less than or equal to 20 minutes.

According to the thirty-fourth aspect A34, a glass-based article, the glass-based article may comprise a first major surface and a second major surface, the first major surface opposite the second major surface, wherein: the treated glass-based article comprises a plurality of surface features extending to a first depth from the first major surface towards the second major surface; the first depth is greater than or equal to 4 nm and less than or equal to 40 nm; a surface roughness (Sq) of the first major surface is less than or equal to 10 nm.

A thirty-fifth aspect A35 includes the glass-based article according to the thirty-fourth aspect A34, wherein the surface roughness (Sq) of the first major surface is less than or equal to 9 nm, less than or equal to 8 nm, less than or equal to 7 nm, less than or equal to 6 nm, or even less than or equal to 5 nm.

A thirty-sixth aspect A36 includes the glass-based article according to the thirty-fourth aspect A34 or thirty-fifth aspect A35, wherein the first major surface comprises a transmittance haze less than or equal to 1% and an opacity less than or equal to 20%.

A thirty-seventh aspect A37 includes the glass-based article according to the thirty-fourth aspect A34 or thirty-fifth aspect A35, wherein the first major surface comprises a gloss of greater than or equal to 80% and an opacity of greater than or equal to 80%.

A thirty-eighth aspect A38 includes the glass-based article according to any one of the thirty-fourth through thirty-seventh aspects A34-A37, comprising a glass ceramic.

A thirty-ninth aspect A39 includes the glass-based article according to any one of the thirty-fourth through thirty-eighth aspects A34-A38, comprising: greater than or equal to 55 wt % and less than or equal to 80 wt % SiO₂; greater than or equal to 2 wt % and less than or equal to 12 wt % Al₂O₃; greater than or equal to 8 wt % and less than or equal to 17 wt % Li₂O; greater than or equal to 0.1 wt % and less than or equal to 5 wt % P₂O₅; greater than or equal to 2 wt % and less than or equal to 15 wt % ZrO₂; and greater than or equal to 0.05 wt % and less than or equal to 4 wt % CaO.

A fortieth aspect A40 includes the glass-based article according to the thirty-ninth aspect A39, wherein the treated glass-based article further comprises one or more of: greater than or equal to 0 wt % and less than or equal to 3 wt % MgO; greater than or equal to 0 wt % and less than or equal to 4 wt % ZnO; greater than or equal to 0 wt % and less than or equal to 5 wt % Na₂O; greater than or equal to 0 wt % and less than or equal to 3 wt % K₂O; and greater than or equal to 0 wt % and less than or equal to 2 wt % Fe₂O₃.

A forty-first aspect A41 includes a vessel for forming a treated glass-based article, wherein: the vessel comprises vessel walls, the vessel walls comprising greater than or equal to 50 wt. % nickel, based on the total weight of the of the vessel walls; an aluminosilicate glass-based article and an etchant are positioned within the vessel; a temperature of the etchant is greater than or equal to 130° C.; and the etchant comprises: greater than or equal to 30 wt % and less than or equal to 100 wt % potassium hydroxide; and less than or equal to 10 wt % sodium hydroxide.

A forty-second aspect A42 includes the vessel according to the forty-first aspect A41, wherein the vessel walls comprise greater than or equal to 60 wt. % nickel, greater than or equal to 70 wt. % nickel, greater than or equal to 80 wt. % nickel, greater than or equal to 90 wt. % nickel, or greater than or equal to 95 wt. % nickel, based on the total weight of the of the vessel walls.

A forty-third aspect A43 includes the vessel according to the forty-first aspect A41 or the forty-second aspect A42, wherein the etchant further comprises greater than 0 wt. % and less than or equal to 70 wt % of a secondary salt, wherein the secondary salt does not comprise sodium.

A forty-fourth aspect A44 includes the vessel according to the forty-third aspect A43, wherein the secondary salt comprises potassium nitrate, potassium sulphate, potassium carbonate, potassium phosphate, calcium hydroxide, or combinations thereof.

A forty-fifth aspect A45 includes the vessel according to any one of the forty-first through the forty-fourth aspects A41-A44, wherein the etchant comprises less than or equal to 10 wt % sodium ions, less than or equal to 5 wt % sodium ions, or even less than or equal to 1 wt % sodium ions.

A forty-sixth aspect A46 includes the vessel according to any one of the forty-first through the forty-fifth aspects A41-A45, wherein the etchant comprises less than or equal to 15 wt. % water, less than or equal to 10 wt. % water, less than or equal to 5 wt. % water, or even than or equal to 1 wt. % water.

A forty-seventh aspect A47 includes the vessel according to any one of the forty-first through the forty-sixth aspects A41-A46, wherein a temperature of the etchant is greater than or equal to 150° C., greater than or equal to 175° C., greater than or equal to 200° C., or even greater than or equal to 225° C.

A forty-eighth aspect A48 includes the vessel according to any one of the forty-first through the forty-seventh aspects A41-A47, wherein a temperature of the etchant is less than or equal to 300° C., less than or equal to 275° C., less than or equal to 250° C., less than or equal to 275° C., or less than or equal to 200° C.

A forty-ninth aspect A49 includes the vessel according to any one of the forty-first through the forty-eighth aspects A41-A48, wherein the etchant comprises: greater than or equal to 30 wt % and less than or equal to 80 wt % potassium hydroxide; and greater than or equal to 20 wt % and less than or equal to 60 wt % of a secondary salt comprising potassium nitrate, potassium sulphate, potassium carbonate, potassium phosphate, or combinations thereof; and a temperature of the etchant is greater than or equal 200° C. and less than or equal to 300° C.

A fiftieth aspect A50 includes the vessel according to any one of the forty-first through the forty-ninth aspects A41-A49, wherein the etchant comprises: greater than or equal to 50 wt % and less than or equal to 70 wt % potassium hydroxide; and greater than or equal to 30 wt % and less than or equal to 50 wt % of water; and a temperature of the etchant is greater than or equal 150° C. and less than or equal to 200° C.

A fifty-first aspect A51 includes the vessel according to any one of the forty-first through the fiftieth aspects A41-A50, wherein the etchant comprises greater than or equal to 30 wt % potassium hydroxide, and greater than or equal to 0 wt % and less than or equal to 70 wt % of a secondary salt comprising potassium nitrate, potassium sulphate, potassium carbonate, potassium phosphate, or combinations thereof.

A fifty-second aspect A52 includes the vessel according to any one of the forty-first through the fifty-first aspects A41-A51, wherein the etchant comprises greater than or equal to 50 wt % and less than or equal to 80 wt % potassium hydroxide, and greater than or equal to 20 wt % and less than or equal to 50 wt % of water.

A fifty-third aspect A53 includes the vessel according to any one of the forty-first through the fifty-second aspects A41-A52, wherein the aluminosilicate glass-based article comprises a surface, and wherein at least a portion of the surface is textured.

A fifty-fourth aspect A54 includes the vessel according to any one of the forty-first through the fifty-third aspects A41-A53, wherein the aluminosilicate glass-based article comprises glass ceramic.

A fifty-fifth aspect A55 includes the vessel according to any one of the forty-first through the fifty-fourth aspects A41-A54, wherein the aluminosilicate glass-based article comprises: greater than or equal to 55 wt % and less than or equal to 80 wt % SiO₂; greater than or equal to 2 wt % and less than or equal to 12 wt % Al₂O₃; greater than or equal to 8 wt % and less than or equal to 17 wt % Li₂O; greater than or equal to 0.1 wt % and less than or equal to 5 wt % P₂O₅; greater than or equal to 2 wt % and less than or equal to 15 wt % ZrO₂; and greater than or equal to 0.05 wt % and less than or equal to 4 wt % CaO.

A fifty-sixth aspect A56 includes the vessel according to the fifty-fifth aspect A55, wherein the aluminosilicate glass-based article further comprises one or more of: greater than or equal to 0 wt % and less than or equal to 3 wt % MgO; greater than or equal to 0 wt % and less than or equal to 4 wt % ZnO; greater than or equal to 0 wt % and less than or equal to 5 wt % Na₂O; greater than or equal to 0 wt % and less than or equal to 3 wt % K₂O; and greater than or equal to 0 wt % and less than or equal to 2 wt % Fe₂O₃.

Additional features and advantages of the treated glass-based articles and the methods of forming the same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts an etchant reacting with an aluminosilicate glass-based article, according to one or more embodiments shown or described herein;

FIG. 1B schematically depicts an etchant reacting with an aluminosilicate glass-based article, according to one or more embodiments shown or described herein;

FIG. 2 schematically depicts a vessel, according to one or more embodiments shown or described herein;

FIG. 3 graphically depicts the haze (y-axis) as a function of Sq (x-axis) of treated glass-based articles, according to one or more embodiments shown or described herein;

FIG. 4 are scanning electron microscope (SEM) images of treated glass-based articles, according to one or more embodiments shown or described herein, and a comparative treated glass-based article;

FIG. 5 is a graphical depiction of a ring-on-ring test of a treated glass-based article, according to one or more embodiments shown or described herein, and a comparative treated glass-based article;

FIG. 6 are scanning electron microscope (SEM) images of treated glass-based articles, according to one or more embodiments shown or described herein, and a comparative treated glass-based article;

FIG. 7 is a graphical depiction of a ring-on-ring test of a treated glass-based article, according to one or more embodiments shown or described herein;

FIG. 8 are photographs of various alloys before and after treatment with an etchant, according to one or more embodiments shown or described herein;

FIG. 9 are SEM images of various alloys before and after treatment with an etchant, according to one or more embodiments shown or described herein;

FIG. 10 are scanning electron microscope-energy dispersive analysis (SEM-EDX) images of a comparative alloy before and after treatment with an etchant;

FIG. 11 are SEM-EDX images of an alloy before and after treatment with an etchant, according to one or more embodiments shown or described herein; and

FIG. 12 graphically depicts a calculated corrosion rate of various alloys before and after treatment with an etchant, according to one or more embodiments shown or described herein.

### DETAILED DESCRIPTION

Reference will now be made in detail to various embodiments of treated glass-based articles having decreased surface roughness, and method of forming treated glass-based articles. According to embodiments, a treated glass-based article comprises: contacting an aluminosilicate glass-based article with an etchant, the etchant comprising: greater than or equal to 30 wt % and less than or equal to 100 wt % potassium hydroxide.

Various embodiments of treated glass-based articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass-based articles described herein, the concentrations of constituent components (e.g., SiO₂, Al₂O₃, and the like) are specified in weight percent (wt %) on an oxide basis, unless otherwise specified.

“Glass-based articles”, as described herein refer to articles comprising glass, such as glass articles and/or glass ceramic articles.

As used herein, the term “glass-ceramic” are solids prepared by controlled crystallization of a precursor glass and have one or more crystalline phases and a residual glass phase.

The terms “free” and “substantially free,” when used to describe the concentration and/or absence of a particular constituent component in a precursor glass or glass-ceramic, means that the constituent component is not intentionally added to the precursor glass or glass-ceramic. However, the precursor glass or glass-ceramic may contain traces of the constituent component as a contaminant or tramp in amounts of less than 0.01 wt %.

As used herein, “surface roughness (Sq)” or “Sq” refers to the root mean square height of a measured profile as described herein. Unless otherwise specified, Sq is measured on a Zygo 7000 with the following settings: Scan size was 180 microns by 220 microns; Objective: 20× Mirau; Image Zoom 2×; Camera resolution 0.2777 microns; Filter: low Pass; Filter Type: Average; Filter Low Wavelength 0; Filter High Wavelength: 0.83169 microns.

As used herein, “surface roughness (Sa)” or “Sa” refers to the arithmetical mean height of a measured profile as described herein. Unless otherwise specified. Sa is measured on a Zygo 7000 with the following settings: Scan size was 180 microns by 220 microns; Objective: 20× Mirau; Image Zoom 2×; Camera resolution 0.2777 microns; Filter: low Pass; Filter Type: Average; Filter Low Wavelength 0; Filter High Wavelength: 0.83169 microns.

Transmittance haze of a glass-based article is measured using a haze meter, such as the BYK Gardner Haze-Gard I, such as following ASTM D1003 or ASTM D1044 on a glass-based article having a thickness of 0.55 mm unless otherwise stated.

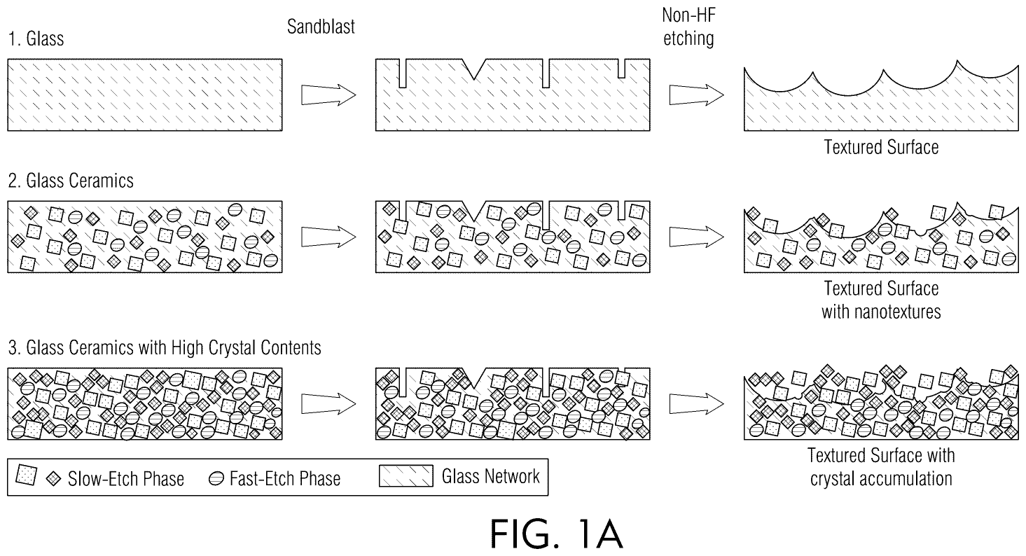

Etchants may be used to reduce a thickness of glass-based articles. Properties of the surfaces of glass-based articles, including the structure, size, and roughness of surface features of the glass-based articles may affect the appearance (e.g. haze), mechanical performance (e.g. surface strength), and/or cleanability of the treated glass-based articles. While conventional etchants, such as those including greater amounts of sodium hydroxide, may be used to etch glass-based articles, such processes may result in differential etching of components of the glass-based articles, which may result in increased surface roughness of a surface of the glass-based articles. Such increased surface roughness may not result in the desired appearance or mechanical performance of the glass-based articles subsequent to the etching. This phenomenon is depicted in FIG. 1A. As shown in FIG. 1A, conventional sandblasting and conventional non-HF etching of glass ceramics may result in articles having a textured surface with nanotextures or crystal accumulation, both of which result in increased surface roughness of the article.

Disclosed herein are treated glass-based articles and methods of forming treated glass-based articles which mitigate the aforementioned problems such that aluminosilicate glass-based articles may be treated to have a lower surface roughness. Specifically, to achieve a lower surface roughness (Sq) of the surface of the treated glass-based articles, the methods of forming the treated glass-based article disclosed herein comprise contacting an aluminosilicate glass-based article with an etchant, the etchant comprising greater than or equal to 30 wt % and less than or equal to 100 wt % potassium hydroxide (KOH) and less than or equal to 10 wt % sodium hydroxide, wherein a temperature of the etchant is greater than or equal to 130° C. during the contacting. To achieve a desired low surface roughness (Sq) of the surface of the treated glass-based article, the etchant in the methods described herein may more uniformly etch different phases of the aluminosilicate glass-based article, resulting in decreased haze and increased mechanical properties as compared to conventional etchants, such as those including greater than 10 wt % sodium hydroxide.

In embodiments, methods of forming a treated glass-based article may comprise contacting an aluminosilicate glass-based article with an etchant.

The aluminosilicate glass-based article and/or the treated glass-based article may be substantially optically clear, transparent and free from light scattering. In such embodiments, the substrate may exhibit an average light transmission over the optical wavelength regime of about 85% or greater, about 86% or greater, about 87% or greater, about 88% or greater, about 89% or greater, about 90% or greater, about 91% or greater or about 92% or greater. In one or more alternative embodiments, the aluminosilicate glass-based article and/or the treated glass-based article may be opaque or exhibit an average light transmission over the optical wavelength regime of less than about 10%, less than about 9%, less than about 8%, less than about 7%, less than about 6%, less than about 5%, less than about 4%, less than about 3%, less than about 2%, less than about 1%, or less than about 0.5%. Unless otherwise specified, the average reflectance or transmittance is measured at an incident illumination angle of 0 degrees (however, such measurements may be provided at incident illumination angles of 45 degrees or 60 degrees).

Additionally or alternatively, the physical thickness of the aluminosilicate glass-based article and/or the treated glass-based article may vary along one or more of its dimensions for aesthetic and/or functional reasons. For example, the edges of the substrate may be thicker as compared to more central regions of the substrate. The length, width and physical thickness dimensions of the substrate may also vary according to the application or use of the treated glass-based article.

In embodiments, the aluminosilicate glass-based article may have a thickness greater than or equal to 0.1 mm and less than or equal to 2.0 mm, greater than or equal to 0.3 mm and less than or equal to 2.0 mm, greater than or equal to 0.5 mm and less than or equal to 2.0 mm, greater than or equal to 0.8 mm and less than or equal to 2.0 mm, greater than or equal to 1.0 mm and less than or equal to 2.0 mm, greater than or equal to 1.3 mm and less than or equal to 2.0 mm, greater than or equal to 1.5 mm and less than or equal to 2.0 mm, greater than or equal to 1.8 mm and less than or equal to 2.0 mm, greater than or equal to 0.1 mm and less than or equal to 1.8 mm, greater than or equal to 0.3 mm and less than or equal to 1.8 mm, greater than or equal to 0.5 mm and less than or equal to 1.8 mm, greater than or equal to 0.8 mm and less than or equal to 1.8 mm, greater than or equal to 1.0 mm and less than or equal to 1.8 mm, greater than or equal to 1.3 mm and less than or equal to 1.8 mm, greater than or equal to 1.5 mm and less than or equal to 1.8 mm, greater than or equal to 0.1 mm and less than or equal to 1.5 mm, greater than or equal to 0.3 mm and less than or equal to 1.5 mm, greater than or equal to 0.5 mm and less than or equal to 1.5 mm, greater than or equal to 0.8 mm and less than or equal to 1.5 mm, greater than or equal to 1.0 mm and less than or equal to 1.5 mm, greater than or equal to 1.3 mm and less than or equal to 1.5 mm, greater than or equal to 0.1 mm and less than or equal to 1.3 mm, greater than or equal to 0.3 mm and less than or equal to 1.3 mm, greater than or equal to 0.5 mm and less than or equal to 1.3 mm, greater than or equal to 0.8 mm and less than or equal to 1.3 mm, greater than or equal to 1.0 mm and less than or equal to 1.3 mm, greater than or equal to 0.1 mm and less than or equal to 1.0 mm, greater than or equal to 0.3 mm and less than or equal to 1.0 mm, greater than or equal to 0.5 mm and less than or equal to 1.0 mm, greater than or equal to 0.8 mm and less than or equal to 1.0 mm, greater than or equal to 0.1 mm and less than or equal to 0.8 mm, greater than or equal to 0.3 mm and less than or equal to 0.8 mm, greater than or equal to 0.5 mm and less than or equal to 0.8 mm, greater than or equal to 0.1 mm and less than or equal to 0.5 mm, greater than or equal to 0.3 mm and less than or equal to 0.5 mm, or greater than or equal to 0.1 mm and less than or equal to 0.3 mm. It should be understood that the above ranges include all subranges within the explicitly disclosed ranges.

In embodiments, the aluminosilicate glass-based article may be substantially planar and flat. In other embodiments, the glass-based article may be shaped, for example it may have a 2.5D or 3D shape. In embodiments, the glass-based article may have a uniform thickness and in other embodiments, the glass-based article may not have a uniform thickness.

In embodiments, the aluminosilicate glass-based article may comprise glass-ceramic, which may be strengthened or non-strengthened. Examples of suitable glass ceramics may include Li₂O—Al₂O₃—SiO₂ system (i.e. LAS-System) glass ceramics, MgO—Al₂O₃—SiO₂ system (i.e. MAS-System) glass ceramics, and/or glass ceramics that include a predominant crystal phase including β-quartz solid solution, β-spodumene ss, cordierite, and lithium disilicate. The glass ceramic substrates may be strengthened using chemical strengthening processes known in the art. Glass-ceramic articles have attributes that can be tailored for use as cover substrates and/or housings for mobile electronic devices. When such glass-ceramic articles are chemically strengthened, for example through ion exchange, the resistance to crack penetration and drop performance can be further enhanced. As another example, the optical characteristics of the glass-ceramic articles, such as transparency and haze, can be tailored through adjusting the heating/ceramming schedule used to turn a glass article into a glass-ceramic article as well as through chemical strengthening, such as through ion exchange, to design or control the properties of the glass-ceramic article.

The aluminosilicate glass-based article comprises SiO₂. In embodiments, the aluminosilicate glass-based article may comprise SiO₂ in an amount greater than or equal to 55 wt % and less than or equal to 80 wt %, greater than or equal to 65 wt % and less than or equal to 80 wt %, greater than or equal to 70 wt % and less than or equal to 80 wt %, greater than or equal to 75 wt % and less than or equal to 80 wt %, greater than or equal to 65 wt % and less than or equal to 75 wt %, greater than or equal to 70 wt % and less than or equal to 75 wt %, or greater than or equal to 65 wt % and less than or equal to 70 wt %. It should be understood that the above ranges include all subranges within the explicitly disclosed range.

The aluminosilicate glass-based article comprises Al₂O₃. Al₂O₃ may also provide stabilization to the network and also provides improved mechanical properties and chemical durability. In embodiments, the aluminosilicate glass-based article may comprise greater than or equal to 2 wt % and less than or equal to 12 wt % Al₂O₃, greater than or equal to 4 wt % and less than or equal to 12 wt % Al₂O₃, greater than or equal to 6 wt % and less than or equal to 12 wt % Al₂O₃, greater than or equal to 8 wt % and less than or equal to 12 wt % Al₂O₃, greater than or equal to 10 wt % and less than or equal to 12 wt % Al₂O₃, greater than or equal to 2 wt % and less than or equal to 10 wt % Al₂O₃, greater than or equal to 4 wt % and less than or equal to 10 wt % Al₂O₃, greater than or equal to 6 wt % and less than or equal to 10 wt % Al₂O₃, greater than or equal to 8 wt % and less than or equal to 10 wt % Al₂O₃, greater than or equal to 2 wt % and less than or equal to 8 wt % Al₂O₃, greater than or equal to 4 wt % and less than or equal to 8 wt % Al₂O₃, greater than or equal to 6 wt % and less than or equal to 8 wt % Al₂O₃, or greater than or equal to 4 wt % and less than or equal to 6 wt % Al₂O₃. It should be understood that the above ranges include all subranges within the explicitly disclosed ranges.

In embodiments, the aluminosilicate glass-based article may comprise Li₂O. In embodiments, the aluminosilicate glass-based article may comprise greater than or equal to 8 wt % and less than or equal to 17 wt % Li₂O, greater than or equal to 10 wt % and less than or equal to 17 wt % Li₂O, greater than or equal to 12 wt % and less than or equal to 17 wt % Li₂O, greater than or equal to 14 wt % and less than or equal to 17 wt % Li₂O, greater than or equal to 16 wt % and less than or equal to 17 wt % Li₂O, greater than or equal to 8 wt % and less than or equal to 16 wt % Li₂O, greater than or equal to 10 wt % and less than or equal to 16 wt % Li₂O, greater than or equal to 12 wt % and less than or equal to 16 wt % Li₂O, greater than or equal to 14 wt % and less than or equal to 16 wt % Li₂O, greater than or equal to 8 wt % and less than or equal to 14 wt % Li₂O, greater than or equal to 10 wt % and less than or equal to 14 wt % Li₂O, greater than or equal to 12 wt % and less than or equal to 14 wt % Li₂O, greater than or equal to 8 wt % and less than or equal to 12 wt % Li₂O, greater than or equal to 10 wt % and less than or equal to 12 wt % Li₂O, or greater than or equal to 8 wt % and less than or equal to 10 wt % Li₂O. It should be understood that the above ranges include all subranges within the explicitly disclosed ranges.

In embodiments, the aluminosilicate glass-based article may comprise P₂O₅. In embodiments, the aluminosilicate glass-based article may comprise greater than or equal to 0.1 wt % and less than or equal to 5.0 wt % P₂O₅, greater than or equal to 0.5 wt % and less than or equal to 5.0 wt % P₂O₅, greater than or equal to 1.0 wt % and less than or equal to 5.0 wt % P₂O₅, greater than or equal to 1.5 wt % and less than or equal to 5.0 wt % P₂O₅, greater than or equal to 2.0 wt % and less than or equal to 5.0 wt % P₂O₅, greater than or equal to 2.5 wt % and less than or equal to 5.0 wt % P₂O₅, greater than or equal to 3.0 wt % and less than or equal to 5.0 wt % P₂O₅, greater than or equal to 0.1 wt % and less than or equal to 3.5 wt % P₂O₅, greater than or equal to 0.5 wt % and less than or equal to 3.5 wt % P₂O₅, greater than or equal to 1.0 wt % and less than or equal to 3.5 wt % P₂O₅, greater than or equal to 1.5 wt % and less than or equal to 3.5 wt % P₂O₅, greater than or equal to 2.0 wt % and less than or equal to 3.5 wt % P₂O₅, greater than or equal to 2.5 wt % and less than or equal to 3.5 wt % P₂O₅, greater than or equal to 3.0 wt % and less than or equal to 3.5 wt % P₂O₅, greater than or equal to 0.1 wt % and less than or equal to 3.0 wt % P₂O₅, greater than or equal to 0.5 wt % and less than or equal to 3.0 wt % P₂O₅, greater than or equal to 1.0 wt % and less than or equal to 3.0 wt % P₂O₅, greater than or equal to 1.5 wt % and less than or equal to 3.0 wt % P₂O₅, greater than or equal to 2.0 wt % and less than or equal to 3.0 wt % P₂O₅, greater than or equal to 2.5 wt % and less than or equal to 3.0 wt % P₂O₅, greater than or equal to 0.1 wt % and less than or equal to 2.5 wt % P₂O₅, greater than or equal to 0.5 wt % and less than or equal to 2.5 wt % P₂O₅, greater than or equal to 1.0 wt % and less than or equal to 2.5 wt % P₂O₅, greater than or equal to 1.5 wt % and less than or equal to 2.5 wt % P₂O₅, greater than or equal to 2.0 wt % and less than or equal to 2.5 wt % P₂O₅, greater than or equal to 0.1 wt % and less than or equal to 2.0 wt % P₂O₅, greater than or equal to 0.5 wt % and less than or equal to 2.0 wt % P₂O₅, greater than or equal to 1.0 wt % and less than or equal to 2.0 wt % P₂O₅, greater than or equal to 1.5 wt % and less than or equal to 2.0 wt % P₂O₅, greater than or equal to 0.1 wt % and less than or equal to 1.5 wt % P₂O₅, greater than or equal to 0.5 wt % and less than or equal to 1.5 wt % P₂O₅, greater than or equal to 1.0 wt % and less than or equal to 1.5 wt % P₂O₅, greater than or equal to 0.1 wt % and less than or equal to 1.0 wt % P₂O₅, greater than or equal to 0.5 wt % and less than or equal to 1.0 wt % P₂O₅, or greater than or equal to 0.1 wt % and less than or equal to 0.5 wt % P₂O₅. It should be understood that the above ranges include all subranges within the explicitly disclosed ranges.

In embodiments, the aluminosilicate glass-based article may comprise ZrO₂. In embodiments, the aluminosilicate glass-based article may comprise greater than or equal to 2 wt % and less than or equal to 15 wt % ZrO₂, greater than or equal to 4 wt % and less than or equal to 15 wt % ZrO₂, greater than or equal to 6 wt % and less than or equal to 15 wt % ZrO₂, greater than or equal to 8 wt % and less than or equal to 15 wt % ZrO₂, greater than or equal to 10 wt % and less than or equal to 15 wt % ZrO₂, greater than or equal to 12 wt % and less than or equal to 15 wt % ZrO₂, greater than or equal to 14 wt % and less than or equal to 15 wt % ZrO₂, greater than or equal to 2 wt % and less than or equal to 14 wt % ZrO₂, greater than or equal to 4 wt % and less than or equal to 14 wt % ZrO₂, greater than or equal to 6 wt % and less than or equal to 14 wt % ZrO₂, greater than or equal to 8 wt % and less than or equal to 14 wt % ZrO₂, greater than or equal to 10 wt % and less than or equal to 14 wt % ZrO₂, greater than or equal to 12 wt % and less than or equal to 14 wt % ZrO₂, greater than or equal to 2 wt % and less than or equal to 12 wt % ZrO₂, greater than or equal to 4 wt % and less than or equal to 12 wt % ZrO₂, greater than or equal to 6 wt % and less than or equal to 12 wt % ZrO₂, greater than or equal to 8 wt % and less than or equal to 12 wt % ZrO₂, greater than or equal to 10 wt % and less than or equal to 12 wt % ZrO₂, greater than or equal to 2 wt % and less than or equal to 10 wt % ZrO₂, greater than or equal to 4 wt % and less than or equal to 10 wt % ZrO₂, greater than or equal to 6 wt % and less than or equal to 10 wt % ZrO₂, greater than or equal to 8 wt % and less than or equal to 10 wt % ZrO₂, greater than or equal to 4 wt % and less than or equal to 8 wt % ZrO₂, greater than or equal to 6 wt % and less than or equal to 8 wt % ZrO₂, or greater than or equal to 4 wt % and less than or equal to 6 wt % ZrO₂. It should be understood that the above ranges include all subranges within the explicitly disclosed ranges.

In embodiments, the aluminosilicate glass-based article may comprise CaO in an amount greater than or equal to 0.05 wt % and less than or equal to 4.0 wt %, greater than or equal to 0.1 wt % and less than or equal to 4.0 wt %, greater than or equal to 0.5 wt % and less than or equal to 4.0 wt %, greater than or equal to 1.0 wt % and less than or equal to 4.0 wt %, greater than or equal to 1.5 wt % and less than or equal to 4.0 wt %, greater than or equal to 2.0 wt % and less than or equal to 4.0 wt %, greater than or equal to 2.5 wt % and less than or equal to 4.0 wt %, greater than or equal to 3.0 wt % and less than or equal to 4.0 wt %, greater than or equal to 3.5 wt % and less than or equal to 4.0 wt %, greater than or equal to 0.05 wt % and less than or equal to 3.5 wt %, greater than or equal to 0.1 wt % and less than or equal to 3.5 wt %, greater than or equal to 0.5 wt % and less than or equal to 3.5 wt %, greater than or equal to 1.0 wt % and less than or equal to 3.5 wt %, greater than or equal to 1.5 wt % and less than or equal to 3.5 wt %, greater than or equal to 2.0 wt % and less than or equal to 3.5 wt %, greater than or equal to 2.5 wt % and less than or equal to 3.5 wt %, greater than or equal to 3.0 wt % and less than or equal to 3.5 wt %, greater than or equal to 0.05 wt % and less than or equal to 3.0 wt %, greater than or equal to 0.1 wt % and less than or equal to 3.0 wt %, greater than or equal to 0.5 wt % and less than or equal to 3.0 wt %, greater than or equal to 1.0 wt % and less than or equal to 3.0 wt %, greater than or equal to 1.5 wt % and less than or equal to 3.0 wt %, greater than or equal to 2.0 wt % and less than or equal to 3.0 wt %, greater than or equal to 2.5 wt % and less than or equal to 3.0 wt %, greater than or equal to 0.05 wt % and less than or equal to 2.5 wt %, greater than or equal to 0.1 wt % and less than or equal to 2.5 wt %, greater than or equal to 0.5 wt % and less than or equal to 2.5 wt %, greater than or equal to 1.0 wt % and less than or equal to 2.5 wt %, greater than or equal to 1.5 wt % and less than or equal to 2.5 wt %, greater than or equal to 2.0 wt % and less than or equal to 2.5 wt %, greater than or equal to 0.05 wt % and less than or equal to 2.0 wt %, greater than or equal to 0.1 wt % and less than or equal to 2.0 wt %, greater than or equal to 0.5 wt % and less than or equal to 2.0 wt %, greater than or equal to 1.0 wt % and less than or equal to 2.0 wt %, greater than or equal to 1.5 wt % and less than or equal to 2.0 wt %, greater than or equal to 0.05 wt % and less than or equal to 1.5 wt %, greater than or equal to 0.1 wt % and less than or equal to 1.5 wt %, greater than or equal to 0.5 wt % and less than or equal to 1.5 wt %, greater than or equal to 1.0 wt % and less than or equal to 1.5 wt %, greater than or equal to 0.05 wt % and less than or equal to 1.0 wt %, greater than or equal to 0.1 wt % and less than or equal to 1.0 wt %, greater than or equal to 0.5 wt % and less than or equal to 1.0 wt %, greater than or equal to 0.05 wt % and less than or equal to 0.5 wt %, greater than or equal to 0.1 wt % and less than or equal to 0.5 wt %, or greater than or equal to 0.05 wt % and less and less than or equal to 0.1 wt %. It should be understood that the above ranges include all subranges within the explicitly disclosed ranges.

In embodiments, the aluminosilicate glass-based article may further include MgO. In embodiments, the aluminosilicate glass-based article may comprise greater than or equal to 0 wt % and less than or equal to 2.0 wt % MgO, greater than or equal to 0 wt % and less than or equal to 1.5 wt % MgO, greater than or equal to 0 wt % and less than or equal to 1.0 wt % MgO, greater than or equal to 0 wt % and less than or equal to 0.5 wt % MgO, greater than or equal to 0.1 wt % and less than or equal to 2.0 wt % MgO, greater than or equal to 0.1 wt % and less than or equal to 1.5 wt % MgO, greater than or equal to 0.1 wt % and less than or equal to 1.0 wt % MgO, or even greater than or equal to 0.1 wt % and less than or equal to 0.5 wt % MgO. In embodiments, the aluminosilicate glass-based article may not include MgO. In embodiments, the aluminosilicate glass-based article may be substantially free of MgO. It should be understood that the above ranges include all subranges within the explicitly disclosed ranges.

In embodiments, the aluminosilicate glass-based article may further include ZnO. In embodiments, the aluminosilicate glass-based article may comprise greater than or equal to 0 wt % and less than or equal to 4.0 wt % ZnO, greater than or equal to 0 wt % and less than or equal to 3.0 wt % ZnO, greater than or equal to 0 wt % and less than or equal to 2.5 wt % ZnO, greater than or equal to 0 wt % and less than or equal to 2.0 wt % ZnO, greater than or equal to 0 wt % and less than or equal to 1.5 wt % ZnO, greater than or equal to 0 wt % and less than or equal to 1.0 wt % ZnO, greater than or equal to 0 wt % and less than or equal to 0.5 wt % ZnO, greater than or equal to 0.1 wt % and less than or equal to 4.0 wt % ZnO, greater than or equal to 0.1 to less than or equal to 3 wt % ZnO, greater than or equal to 0.1 wt % and less than or equal to 2.5 wt % ZnO, greater than or equal to 0.1 wt % and less than or equal to 2.0 wt % ZnO, greater than or equal to 0.1 wt % and less than or equal to 1.5 wt % ZnO, greater than or equal to 0.1 wt % and less than or equal to 1.0 wt % ZnO, or even greater than or equal to 0.1 wt % and less than or equal to 0.5 wt % ZnO. In embodiments, the aluminosilicate glass-based article may not include ZnO. In embodiments, the aluminosilicate glass-based article may be substantially free of ZnO. It should be understood that the above ranges include all subranges within the explicitly disclosed ranges.

In embodiments, the aluminosilicate glass-based article may further include Na₂O. In embodiments, the aluminosilicate glass-based article may comprise greater than or equal to 0 wt % and less than or equal to 5 wt % Na₂O, greater than or equal to 0 wt % and less than or equal to 2 wt % Na₂O, greater than or equal to 1 wt % and less than or equal to 2 wt % Na₂O, greater than or equal to 0 wt % and less than or equal to 1 wt % Na₂O. In embodiments, the aluminosilicate glass-based article may not include Na₂O. In embodiments, the aluminosilicate glass-based article may be substantially free of Na₂O. It should be understood that the above ranges include all subranges within the explicitly disclosed ranges.

In embodiments, the aluminosilicate glass-based article may further include K₂O. In embodiments, the aluminosilicate glass-based article may comprise greater than or equal to 0 wt % and less than or equal to 3 wt % K₂O, greater than or equal to 0 wt % and less than or equal to 2 wt % K₂O, greater than or equal to 0 wt % and less than or equal to 1 wt % K₂O, greater than or equal to 0.05 wt % and less than or equal to 1 wt % K₂O or even greater than or equal to 0.1 wt % and less than or equal to 1 wt % K₂O. In embodiments, the aluminosilicate glass-based article may not include K₂O. In embodiments, the aluminosilicate glass-based article may be substantially free of K₂O. It should be understood that the above ranges include all subranges within the explicitly disclosed ranges.

In embodiments, the aluminosilicate glass-based article may comprise Fe₂O₃. In embodiments, the glass and glass-ceramic comprises greater than 0.0 wt % and less than or equal to 1.5 wt % Fe₂O₃, greater than or equal to 0.5 wt % and less than or equal to 1.5 wt % Fe₂O₃, greater than or equal to 1.0 wt % and less than or equal to 1.5 wt % Fe₂O₃, greater than 0.0 wt % and less than or equal to 1.0 wt % Fe₂O₃, greater than or equal to 0.5 wt % and less than or equal to 1.0 wt % Fe₂O₃, or greater than 0.0 wt % and less than or equal to 0.5 wt % Fe₂O₃. In embodiments, the aluminosilicate glass-based article may not include Fe₂O₃. In embodiments, the aluminosilicate glass-based article may be substantially free of Fe₂O₃. It should be understood that the above ranges include all subranges within the explicitly disclosed ranges.

In embodiments, the aluminosilicate glass-based article may further include SrO. In embodiments, the aluminosilicate glass-based article may comprise greater than or equal to 0 wt % and less than or equal to 2.0 wt % SrO, greater than or equal to 0 wt % and less than or equal to 1.5 wt % SrO, greater than or equal to 0 wt % and less than or equal to 1.0 wt % SrO, greater than or equal to 0 wt % and less than or equal to 0.5 wt % SrO, greater than or equal to 0.1 wt % and less than or equal to 2.0 wt % SrO, greater than or equal to 0.1 wt % and less than or equal to 1.5 wt % SrO, greater than or equal to 0.1 wt % and less than or equal to 1.0 wt % SrO, or even greater than or equal to 0.1 wt % and less than or equal to 0.5 wt % SrO. In embodiments, the aluminosilicate glass-based article does not include SrO. In embodiments, the aluminosilicate glass-based article is substantially free of SrO. It should be understood that the above ranges include all subranges within the explicitly disclosed ranges.

In embodiments, the aluminosilicate glass-based article may further include BaO. In embodiments, the aluminosilicate glass-based article may comprise greater than or equal to 0 wt % and less than or equal to 2.0 wt % BaO, greater than or equal to 0 wt % and less than or equal to 1.5 wt % BaO, greater than or equal to 0 wt % and less than or equal to 1.0 wt % BaO, greater than or equal to 0 wt % and less than or equal to 0.5 wt % BaO, greater than or equal to 0.1 wt % and less than or equal to 2.0 wt % BaO, greater than or equal to 0.1 wt % and less than or equal to 1.5 wt % BaO, greater than or equal to 0.1 wt % and less than or equal to 1.0 wt % BaO, or even greater than or equal to 0.1 wt % and less than or equal to 0.5 wt % BaO. In embodiments, the aluminosilicate glass-based article does not include BaO. In embodiments, the aluminosilicate glass-based article is substantially free of BaO. It should be understood that the above ranges include all subranges within the explicitly disclosed ranges.

In embodiments, the aluminosilicate glass-based article may further include B₂O₃. Without wishing to be bound by theory, it is believed that additions of B₂O₃ may partition into the amorphous residual glass. In embodiments, the aluminosilicate glass-based article may comprise greater than or equal to 0 wt % and less than or equal to 2.0 wt % B₂O₃, greater than or equal to 0 wt % and less than or equal to 1.5 wt % B₂O₃, greater than or equal to 0 wt % and less than or equal to 1.0 wt % B₂O₃, greater than or equal to 0 wt % and less than or equal to 0.5 wt % B₂O₃, greater than or equal to 0.1 wt % and less than or equal to 2.0 wt % B₂O₃, greater than or equal to 0.1 wt % and less than or equal to 1.5 wt % B₂O₃, greater than or equal to 0.1 wt % and less than or equal to 1.0 wt % B₂O₃, or even greater than or equal to 0.1 wt % and less than or equal to 0.5 wt % B₂O₃. In embodiments, the aluminosilicate glass-based article does not include B₂O₃. In embodiments, the aluminosilicate glass-based article is substantially free of B₂O₃. It should be understood that the above ranges include all subranges within the explicitly disclosed ranges.

In embodiments, the aluminosilicate glass-based article may further include HfO₂. In embodiments, the aluminosilicate glass-based article may comprise greater than or equal to 0 wt % and less than or equal to 3.0 wt % HfO₂, greater than or equal to 0 wt % and less than or equal to 2.5 wt % HfO₂, greater than or equal to 0 wt % and less than or equal to 2.0 wt % HfO₂, greater than or equal to 0 wt % and less than or equal to 1.5 wt % HfO₂, greater than or equal to 0 wt % and less than or equal to 1.0 wt % HfO₂, greater than or equal to 0 wt % and less than or equal to 0.5 wt % HfO₂, greater than or equal to 0.1 to less than or equal to 3 wt % HfO₂, greater than or equal to 0.1 wt % and less than or equal to 2.5 wt % HfO₂, greater than or equal to 0.1 wt % and less than or equal to 2.0 wt % HfO₂, greater than or equal to 0.1 wt % and less than or equal to 1.5 wt % HfO₂, greater than or equal to 0.1 wt % and less than or equal to 1.0 wt % HfO₂, or even greater than or equal to 0.1 wt % and less than or equal to 0.5 wt % HfO₂. In embodiments, the aluminosilicate glass-based article does not include HfO₂. In embodiments, the aluminosilicate glass-based article is substantially free of HfO₂. It should be understood that the above ranges include all subranges within the explicitly disclosed ranges.

In embodiments, the aluminosilicate glass-based article may further include Y₂O₃. Without wishing to be bound by theory, it is believed that additions of Y₂O₃ may increase the refractive index of the aluminosilicate glass-based article. In embodiments, the aluminosilicate glass-based article may comprise greater than or equal to 0 wt % and less than or equal to 2.0 wt % Y₂O₃, greater than or equal to 0 wt % and less than or equal to 1.5 wt % Y₂O₃, greater than or equal to 0 wt % and less than or equal to 1.0 wt % Y₂O₃, greater than or equal to 0 wt % and less than or equal to 0.5 wt % Y₂O₃, greater than or equal to 0.1 wt % and less than or equal to 2.0 wt % Y₂O₃, greater than or equal to 0.1 wt % and less than or equal to 1.5 wt % Y₂O₃, greater than or equal to 0.1 wt % and less than or equal to 1.0 wt % Y₂O₃, or even greater than or equal to 0.1 wt % and less than or equal to 0.5 wt % Y₂O₃. In embodiments, the aluminosilicate glass-based article does not include Y₂O₃. In embodiments, the aluminosilicate glass-based article is substantially free of Y₂O₃. It should be understood that the above ranges include all subranges within the explicitly disclosed ranges.

In embodiments, the aluminosilicate glass-based article may further include La₂O₃. Without wishing to be bound by theory, it is believed that additions of La₂O₃ may increase the refractive index of the aluminosilicate glass-based article. In embodiments, the aluminosilicate glass-based article may comprise greater than or equal to 0 wt % and less than or equal to 2.0 wt % La₂O₃, greater than or equal to 0 wt % and less than or equal to 1.5 wt % La₂O₃, greater than or equal to 0 wt % and less than or equal to 1.0 wt % La₂O₃, greater than or equal to 0 wt % and less than or equal to 0.5 wt % La₂O₃, greater than or equal to 0.1 wt % and less than or equal to 2.0 wt % La₂O₃, greater than or equal to 0.1 wt % and less than or equal to 1.5 wt % La₂O₃, greater than or equal to 0.1 wt % and less than or equal to 1.0 wt % La₂O₃, or even greater than or equal to 0.1 wt % and less than or equal to 0.5 wt % La₂O₃. In embodiments, the aluminosilicate glass-based article does not include La₂O₃. In embodiments, the aluminosilicate glass-based article is substantially free of La₂O₃. It should be understood that the above ranges include all subranges within the explicitly disclosed ranges.

In embodiments, the aluminosilicate glass-based article may further include CeO₂. In embodiments, the aluminosilicate glass-based article may comprise greater than or equal to 0 wt % and less than or equal to 2.0 wt % CeO₂, greater than or equal to 0 wt % and less than or equal to 1.5 wt % CeO₂, greater than or equal to 0 wt % and less than or equal to 1.0 wt % CeO₂, greater than or equal to 0 wt % and less than or equal to 0.5 wt % CeO₂, greater than or equal to 0.1 wt % and less than or equal to 2.0 wt % CeO₂, greater than or equal to 0.1 wt % and less than or equal to 1.5 wt % CeO₂, greater than or equal to 0.1 wt % and less than or equal to 1.0 wt % CeO₂, or even greater than or equal to 0.1 wt % and less than or equal to 0.5 wt % CeO₂. In embodiments, the aluminosilicate glass-based article does not include CeO₂. In embodiments, the aluminosilicate glass-based article is substantially free of CeO₂. It should be understood that the above ranges include all subranges within the explicitly disclosed ranges.

In embodiments, the aluminosilicate glass-based article may further include Eu₂O₃. In embodiments, the aluminosilicate glass-based article may comprise greater than or equal to 0 wt % and less than or equal to 2.0 wt % Eu₂O₃, greater than or equal to 0 wt % and less than or equal to 1.5 wt % Eu₂O₃, greater than or equal to 0 wt % and less than or equal to 1.0 wt % Eu₂O₃, greater than or equal to 0 wt % and less than or equal to 0.5 wt % Eu₂O₃, greater than or equal to 0.1 wt % and less than or equal to 2.0 wt % Eu₂O₃, greater than or equal to 0.1 wt % and less than or equal to 1.5 wt % Eu₂O₃, greater than or equal to 0.1 wt % and less than or equal to 1.0 wt % Eu₂O₃, or even greater than or equal to 0.1 wt % and less than or equal to 0.5 wt % Eu₂O₃. In embodiments, the aluminosilicate glass-based article does not include Eu₂O₃. In embodiments, the aluminosilicate glass-based article is substantially free of Eu₂O₃. It should be understood that the above ranges include all subranges within the explicitly disclosed ranges.

In embodiments, the aluminosilicate glass-based article may further include Dy₂O₃. In embodiments, the aluminosilicate glass-based article may comprise greater than or equal to 0 wt % and less than or equal to 2.0 wt % Dy₂O₃, greater than or equal to 0 wt % and less than or equal to 1.5 wt % Dy₂O₃, greater than or equal to 0 wt % and less than or equal to 1.0 wt % Dy₂O₃, greater than or equal to 0 wt % and less than or equal to 0.5 wt % Dy₂O₃, greater than or equal to 0.1 wt % and less than or equal to 2.0 wt % Dy₂O₃, greater than or equal to 0.1 wt % and less than or equal to 1.5 wt % Dy₂O₃, greater than or equal to 0.1 wt % and less than or equal to 1.0 wt % Dy₂O₃, or even greater than or equal to 0.1 wt % and less than or equal to 0.5 wt % Dy₂O₃. In embodiments, the aluminosilicate glass-based article does not include Dy₂O₃. In embodiments, the aluminosilicate glass-based article is substantially free of Dy₂O₃. It should be understood that the above ranges include all subranges within the explicitly disclosed ranges.

In embodiments, the aluminosilicate glass-based article may further include Tb₄O₇. In embodiments, the aluminosilicate glass-based article may comprise greater than or equal to 0 wt % and less than or equal to 2.0 wt % Tb₄O₇, greater than or equal to 0 wt % and less than or equal to 1.5 wt % Tb₄O₇, greater than or equal to 0 wt % and less than or equal to 1.0 wt % Tb₄O₇, greater than or equal to 0 wt % and less than or equal to 0.5 wt % Tb₄O₇, greater than or equal to 0.1 wt % and less than or equal to 2.0 wt % Tb₄O₇, greater than or equal to 0.1 wt % and less than or equal to 1.5 wt % Tb₄O₇, greater than or equal to 0.1 wt % and less than or equal to 1.0 wt % Tb₄O₇, or even greater than or equal to 0.1 wt % and less than or equal to 0.5 wt % Tb₄O₇. In embodiments, the aluminosilicate glass-based article does not include Tb₄O₇. In embodiments, the aluminosilicate glass-based article is substantially free of Tb₄O₇. It should be understood that the above ranges include all subranges within the explicitly disclosed ranges.

In embodiments, the aluminosilicate glass-based article may further include Yb₂O₃. In embodiments, the aluminosilicate glass-based article may comprise greater than or equal to 0 wt % and less than or equal to 2.0 wt % Yb₂O₃, greater than or equal to 0 wt % and less than or equal to 1.5 wt % Yb₂O₃, greater than or equal to 0 wt % and less than or equal to 1.0 wt % Yb₂O₃, greater than or equal to 0 wt % and less than or equal to 0.5 wt % Yb₂O₃, greater than or equal to 0.1 wt % and less than or equal to 2.0 wt % Yb₂O₃, greater than or equal to 0.1 wt % and less than or equal to 1.5 wt % Yb₂O₃, greater than or equal to 0.1 wt % and less than or equal to 1.0 wt % Yb₂O₃, or even greater than or equal to 0.1 wt % and less than or equal to 0.5 wt % Yb₂O₃. In embodiments, the aluminosilicate glass-based article does not include Yb₂O₃. In embodiments, the aluminosilicate glass-based article is substantially free of Yb₂O₃. It should be understood that the above ranges include all subranges within the explicitly disclosed ranges.

In embodiments, the aluminosilicate glass-based article may further include Gd₂O₃. In embodiments, the aluminosilicate glass-based article may comprise greater than or equal to 0 wt % and less than or equal to 2.0 wt % Gd₂O₃, greater than or equal to 0 wt % and less than or equal to 1.5 wt % Gd₂O₃, greater than or equal to 0 wt % and less than or equal to 1.0 wt % Gd₂O₃, greater than or equal to 0 wt % and less than or equal to 0.5 wt % Gd₂O₃, greater than or equal to 0.1 wt % and less than or equal to 2.0 wt % Gd₂O₃, greater than or equal to 0.1 wt % and less than or equal to 1.5 wt % Gd₂O₃, greater than or equal to 0.1 wt % and less than or equal to 1.0 wt % Gd₂O₃, or even greater than or equal to 0.1 wt % and less than or equal to 0.5 wt % Gd₂O₃. In embodiments, the aluminosilicate glass-based article does not include Gd₂O₃. In embodiments, the aluminosilicate glass-based article is substantially free of Gd₂O₃. It should be understood that the above ranges include all subranges within the explicitly disclosed ranges.

In embodiments, the aluminosilicate glass-based article may further include Tm₂O₃. In embodiments, the aluminosilicate glass-based article may comprise greater than or equal to 0 wt % and less than or equal to 2.0 wt % Tm₂O₃, greater than or equal to 0 wt % and less than or equal to 1.5 wt % Tm₂O₃, greater than or equal to 0 wt % and less than or equal to 1.0 wt % Tm₂O₃, greater than or equal to 0 wt % and less than or equal to 0.5 wt % Tm₂O₃, greater than or equal to 0.1 wt % and less than or equal to 2.0 wt % Tm₂O₃, greater than or equal to 0.1 wt % and less than or equal to 1.5 wt % Tm₂O₃, greater than or equal to 0.1 wt % and less than or equal to 1.0 wt % Tm₂O₃, or even greater than or equal to 0.1 wt % and less than or equal to 0.5 wt % Tm₂O₃. In embodiments, the aluminosilicate glass-based article does not include Tm₂O₃. In embodiments, the aluminosilicate glass-based article is substantially free of Tm₂O₃. It should be understood that the above ranges include all subranges within the explicitly disclosed ranges.

In embodiments, the aluminosilicate glass-based article may further include Lu₂O₃. In embodiments, the aluminosilicate glass-based article may comprise greater than or equal to 0 wt % and less than or equal to 2.0 wt % Lu₂O₃, greater than or equal to 0 wt % and less than or equal to 1.5 wt % Lu₂O₃, greater than or equal to 0 wt % and less than or equal to 1.0 wt % Lu₂O₃, greater than or equal to 0 wt % and less than or equal to 0.5 wt % Lu₂O₃, greater than or equal to 0.1 wt % and less than or equal to 2.0 wt % Lu₂O₃, greater than or equal to 0.1 wt % and less than or equal to 1.5 wt % Lu₂O₃, greater than or equal to 0.1 wt % and less than or equal to 1.0 wt % Lu₂O₃, or even greater than or equal to 0.1 wt % and less than or equal to 0.5 wt % Lu₂O₃. In embodiments, the aluminosilicate glass-based article does not include Lu₂O₃. In embodiments, the aluminosilicate glass-based article is substantially free of Lu₂O₃. It should be understood that the above ranges include all subranges within the explicitly disclosed ranges.

In embodiments, the aluminosilicate glass-based article may further include Nd₂O₃. In embodiments, the aluminosilicate glass-based article may comprise greater than or equal to 0 wt % and less than or equal to 0.5 wt % Nd₂O₃, greater than or equal to 0 wt % and less than or equal to 0.4 wt % Nd₂O₃, greater than or equal to 0 wt % and less than or equal to 0.3 wt % Nd₂O₃, greater than or equal to 0 wt % and less than or equal to 0.2 wt % Nd₂O₃, greater than or equal to 0 wt % and less than or equal to 0.1 wt % Nd₂O₃, greater than or equal to 0.1 wt % and less than or equal to 0.5 wt % Nd₂O₃, greater than or equal to 0.1 wt % and less than or equal to 0.4 wt % Nd₂O₃, greater than or equal to 0.1 wt % and less than or equal to 0.3 wt % Nd₂O₃, or even greater than or equal to 0.1 wt % and less than or equal to 0.2 wt % Nd₂O₃. In embodiments, the aluminosilicate glass-based article does not include Nd₂O₃. In embodiments, the aluminosilicate glass-based article is substantially free of Nd₂O₃. It should be understood that the above ranges include all subranges within the explicitly disclosed ranges.

In embodiments, the aluminosilicate glass-based article may further include Pr₂O₃. In embodiments, the aluminosilicate glass-based article may comprise greater than or equal to 0 wt % and less than or equal to 0.5 wt % Pr₂O₃, greater than or equal to 0 wt % and less than or equal to 0.4 wt % Pr₂O₃, greater than or equal to 0 wt % and less than or equal to 0.3 wt % Pr₂O₃, greater than or equal to 0 wt % and less than or equal to 0.2 wt % Pr₂O₃, greater than or equal to 0 wt % and less than or equal to 0.1 wt % Pr₂O₃, greater than or equal to 0.1 wt % and less than or equal to 0.5 wt % Pr₂O₃, greater than or equal to 0.1 wt % and less than or equal to 0.4 wt % Pr₂O₃, greater than or equal to 0.1 wt % and less than or equal to 0.3 wt % Pr₂O₃, or even greater than or equal to 0.1 wt % and less than or equal to 0.2 wt % Pr₂O₃. In embodiments, the aluminosilicate glass-based article does not include Pr₂O₃. In embodiments, the aluminosilicate glass-based article is substantially free of Pr₂O₃. It should be understood that the above ranges include all subranges within the explicitly disclosed ranges.

In embodiments, the aluminosilicate glass-based article may further include Er₂O₃. In embodiments, the aluminosilicate glass-based article may comprise greater than or equal to 0 wt % and less than or equal to 0.5 wt % Er₂O₃, greater than or equal to 0 wt % and less than or equal to 0.4 wt % Er₂O₃, greater than or equal to 0 wt % and less than or equal to 0.3 wt % Er₂O₃, greater than or equal to 0 wt % and less than or equal to 0.2 wt % Er₂O₃, greater than or equal to 0 wt % and less than or equal to 0.1 wt % Er₂O₃, greater than or equal to 0.1 wt % and less than or equal to 0.5 wt % Er₂O₃, greater than or equal to 0.1 wt % and less than or equal to 0.4 wt % Er₂O₃, greater than or equal to 0.1 wt % and less than or equal to 0.3 wt % Er₂O₃, or even greater than or equal to 0.1 wt % and less than or equal to 0.2 wt % Er₂O₃. In embodiments, the aluminosilicate glass-based article does not include Er₂O₃. In embodiments, the aluminosilicate glass-based article is substantially free of Er₂O₃. It should be understood that the above ranges include all subranges within the explicitly disclosed ranges.

In embodiments, the aluminosilicate glass-based article may further include Sm₂O₃. In embodiments, the aluminosilicate glass-based article may comprise greater than or equal to 0 wt % and less than or equal to 0.5 wt % Sm₂O₃, greater than or equal to 0 wt % and less than or equal to 0.4 wt % Sm₂O₃, greater than or equal to 0 wt % and less than or equal to 0.3 wt % Sm₂O₃, greater than or equal to 0 wt % and less than or equal to 0.2 wt % Sm₂O₃, greater than or equal to 0 wt % and less than or equal to 0.1 wt % Sm₂O₃, greater than or equal to 0.1 wt % and less than or equal to 0.5 wt % Sm₂O₃, greater than or equal to 0.1 wt % and less than or equal to 0.4 wt % Sm₂O₃, greater than or equal to 0.1 wt % and less than or equal to 0.3 wt % Sm₂O₃, or even greater than or equal to 0.1 wt % and less than or equal to 0.2 wt % Sm₂O₃. In embodiments, the aluminosilicate glass-based article does not include Sm₂O₃. In embodiments, the aluminosilicate glass-based article is substantially free of Sm₂O₃. It should be understood that the above ranges include all subranges within the explicitly disclosed ranges.

In embodiments, the aluminosilicate glass-based article may further include Ho₂O₃. In embodiments, the aluminosilicate glass-based article may comprise greater than or equal to 0 wt % and less than or equal to 0.5 wt % Ho₂O₃, greater than or equal to 0 wt % and less than or equal to 0.4 wt % Ho₂O₃, greater than or equal to 0 wt % and less than or equal to 0.3 wt % Ho₂O₃, greater than or equal to 0 wt % and less than or equal to 0.2 wt % Ho₂O₃, greater than or equal to 0 wt % and less than or equal to 0.1 wt % Ho₂O₃, greater than or equal to 0.1 wt % and less than or equal to 0.5 wt % Ho₂O₃, greater than or equal to 0.1 wt % and less than or equal to 0.4 wt % Ho₂O₃, greater than or equal to 0.1 wt % and less than or equal to 0.3 wt % Ho₂O₃, or even greater than or equal to 0.1 wt % and less than or equal to 0.2 wt % Ho₂O₃. In embodiments, the aluminosilicate glass-based article does not include Ho₂O₃. In embodiments, the aluminosilicate glass-based article is substantially free of Ho₂O₃. It should be understood that the above ranges include all subranges within the explicitly disclosed ranges.

In embodiments, the aluminosilicate glass-based article may further include Pm₂O₃. In embodiments, the aluminosilicate glass-based article may comprise greater than or equal to 0 wt % and less than or equal to 0.5 wt % Pm₂O₃, greater than or equal to 0 wt % and less than or equal to 0.4 wt % Pm₂O₃, greater than or equal to 0 wt % and less than or equal to 0.3 wt % Pm₂O₃, greater than or equal to 0 wt % and less than or equal to 0.2 wt % Pm₂O₃, greater than or equal to 0 wt % and less than or equal to 0.1 wt % Pm₂O₃, greater than or equal to 0.1 wt % and less than or equal to 0.5 wt % Pm₂O₃, greater than or equal to 0.1 wt % and less than or equal to 0.4 wt % Pm₂O₃, greater than or equal to 0.1 wt % and less than or equal to 0.3 wt % Pm₂O₃, or even greater than or equal to 0.1 wt % and less than or equal to 0.2 wt % Pm₂O₃. In embodiments, the aluminosilicate glass-based article does not include Pm₂O₃. In embodiments, the aluminosilicate glass-based article is substantially free of Pm₂O₃. It should be understood that the above ranges include all subranges within the explicitly disclosed ranges.

In embodiments, the aluminosilicate glass-based article may further include Ta₂O₅. Without wishing to be bound by theory, it is believed that additions of Ta₂O₅ may increase the refractive index of the aluminosilicate glass-based article. In embodiments, the aluminosilicate glass-based article may comprise greater than or equal to 0 wt % and less than or equal to 2.0 wt % Ta₂O₅, greater than or equal to 0 wt % and less than or equal to 1.5 wt % Ta₂O₅, greater than or equal to 0 wt % and less than or equal to 1.0 wt % Ta₂O₅, greater than or equal to 0 wt % and less than or equal to 0.5 wt % Ta₂O₅, greater than or equal to 0.1 wt % and less than or equal to 2.0 wt % Ta₂O₅, greater than or equal to 0.1 wt % and less than or equal to 1.5 wt % Ta₂O₅, greater than or equal to 0.1 wt % and less than or equal to 1.0 wt % Ta₂O₅, or even greater than or equal to 0.1 wt % and less than or equal to 0.5 wt % Ta₂O₅. In embodiments, the aluminosilicate glass-based article does not include Ta₂O₅. In embodiments, the aluminosilicate glass-based article is substantially free of Ta₂O₅. It should be understood that the above ranges include all subranges within the explicitly disclosed ranges.

In embodiments, the aluminosilicate glass-based article may further include GeO₂. Without wishing to be bound by theory, it is believed that additions of GeO₂ may increase the refractive index of the aluminosilicate glass-based article. In embodiments, the aluminosilicate glass-based article may comprise greater than or equal to 0 wt % and less than or equal to 5.0 wt % GeO₂, greater than or equal to 0 wt % and less than or equal to 4.5 wt % GeO₂, greater than or equal to 0 wt % and less than or equal to 4.0 wt % GeO₂, greater than or equal to 0 wt % and less than or equal to 3.5 wt % GeO₂, greater than or equal to 0 wt % and less than or equal to 3.0 wt % GeO₂, greater than or equal to 0 wt % and less than or equal to 2.5 wt % GeO₂, greater than or equal to 0 wt % and less than or equal to 2.0 wt % GeO₂, greater than or equal to 0 wt % and less than or equal to 1.5 wt % GeO₂, greater than or equal to 0 wt % and less than or equal to 1.0 wt % GeO₂, greater than or equal to 0 wt % and less than or equal to 0.5 wt % GeO₂, greater than or equal to 0.1 wt % and less than or equal to 5.0 wt % GeO₂, greater than or equal to 0.1 wt % and less than or equal to 4.5 wt % GeO₂, greater than or equal to 0.1 wt % and less than or equal to 4.0 wt % GeO₂, greater than or equal to 0.1 wt % and less than or equal to 3.5 wt % GeO₂, greater than or equal to 0.1 wt % and less than or equal to 3.0 wt % GeO₂, greater than or equal to 0.1 wt % and less than or equal to 2.5 wt % GeO₂, greater than or equal to 0.1 wt % and less than or equal to 2.0 wt % GeO₂, greater than or equal to 0.1 wt % and less than or equal to 1.5 wt % GeO₂, greater than or equal to 0.1 wt % and less than or equal to 1.0 wt % GeO₂, or even greater than or equal to 0.1 wt % and less than or equal to 0.5 wt % GeO₂. In embodiments, the aluminosilicate glass-based article does not include GeO₂. In embodiments, the aluminosilicate glass-based article is substantially free of GeO₂. It should be understood that the above ranges include all subranges within the explicitly disclosed ranges.

In embodiments, the aluminosilicate glass-based article may further include TiO₂. In embodiments, the aluminosilicate glass-based article may comprise greater than or equal to 0 wt % and less than or equal to 2.0 wt % TiO₂, greater than or equal to 0 wt % and less than or equal to 1.5 wt % TiO₂, greater than or equal to 0 wt % and less than or equal to 1.0 wt % TiO₂, greater than or equal to 0 wt % and less than or equal to 0.5 wt % TiO₂, greater than or equal to 0.1 wt % and less than or equal to 2.0 wt % TiO₂, greater than or equal to 0.1 wt % and less than or equal to 1.5 wt % TiO₂, greater than or equal to 0.1 wt % and less than or equal to 1.0 wt % TiO₂, or even greater than or equal to 0.1 wt % and less than or equal to 0.5 wt % TiO₂. In embodiments, the aluminosilicate glass-based article does not include TiO₂. In embodiments, the aluminosilicate glass-based article is substantially free of TiO₂. It should be understood that the above ranges include all subranges within the explicitly disclosed ranges.

In embodiments, the aluminosilicate glass-based article may further include a chemical fining agent. Such fining agents include, but are not limited to, SnO₂, As₂O₃, Sb₂O₃, SO₃ F, CI and Br. In some embodiments, the concentrations of the chemical fining agents are kept at a level of 3, 2, 1, or 0.5, >0 wt %. In embodiments, the chemical fining agent is SnO₂ and the aluminosilicate glass-based article may comprise greater than or equal to 0 to less than or equal to 3 wt % SnO₂. In embodiments, the aluminosilicate glass-based article may comprise greater than or equal to 0 wt % and less than or equal to 2.5 wt % SnO₂, greater than or equal to 0 wt % and less than or equal to 2.0 wt % SnO₂, greater than or equal to 0 wt % and less than or equal to 1.5 wt % SnO₂, greater than or equal to 0 wt % and less than or equal to 1.0 wt % SnO₂, greater than or equal to 0 wt % and less than or equal to 0.5 wt % SnO₂, greater than 0.01 wt % to less than or equal to 3 wt % SnO₂, greater than 0.01 wt % and less than or equal to 2.5 wt % SnO₂, greater than 0.01 wt % and less than or equal to 2.0 wt % SnO₂, greater than 0.01 wt % and less than or equal to 1.5 wt % SnO₂, greater than 0.01 wt % and less than or equal to 1.0 wt % SnO₂, or even greater than 0.01 wt % and less than or equal to 0.5 wt % SnO₂. It should be understood that the above ranges include all subranges within the explicitly disclosed ranges. In embodiments, the chemical fining agent may also include CeO₂, Fe₂O₃, and other oxides of transition metals, such as MnO₂. These oxides may introduce unwanted color to the aluminosilicate glass-based article via visible absorptions in their final valence state(s) in the glass, and thus, when present, their concentration is usually kept at a level of 0.5, 0.4, 0.3, 0.2, 0.1 or >0 wt %. In embodiments, the aluminosilicate glass-based article does not include a chemical fining agent.

In some embodiments, the aluminosilicate glass-based article can be substantially free of Sb₂O₃, As₂O₃, or combinations thereof. For example, the precursor glass or glass-ceramic can comprise 0.05 weight percent or less of Sb₂O₃ or As₂O₃ or a combination thereof, the aluminosilicate glass-based article may comprise 0 wt % of Sb₂O₃ or As₂O₃ or a combination thereof, or the aluminosilicate glass-based article may be, for example, free of any intentionally added Sb₂O₃, As₂O₃, or combinations thereof.

Additional details on aluminosilicate glass-based articles suitable for use in various embodiments may be found in, for example, U.S. Patent Application Publication No. 2016/0102010 entitled “High Strength Glass-Ceramics Having Petalite and Lithium Silicate Structures,” filed Oct. 8, 2015, which is incorporated by reference herein in its entirety.

By way of example and not limitation, in various embodiments, the aluminosilicate glass-based article may comprise greater than or equal to 55 wt % and less than or equal to 80 wt % SiO₂, greater than or equal to 2 wt % and less than or equal to 12 wt % Al₂O₃, greater than or equal to 8 wt % and less than or equal to 17 wt % Li₂O, greater than or equal to 0.10 wt % and less than or equal to 5 wt % P₂O₅, greater than or equal to 2 and less than or equal to 15 wt % ZrO₂, and greater than or equal to 0.05 wt % and less than or equal to 4 wt % CaO.

The etchant used in the methods disclosed herein comprises KOH. In embodiments, the etchant may comprise KOH in an amount of greater than or equal to 30 wt % and less than or equal to 100 wt %, greater than or equal to 40 wt % and less than or equal to 100 wt %, greater than or equal to 50 wt % and less than or equal to 100 wt %, greater than or equal to 60 wt % and less than or equal to 100 wt %, greater than or equal to 65 wt % and less than or equal to 100 wt %, greater than or equal to 30 wt % and less than or equal to 90 wt %, greater than or equal to 40 wt % and less than or equal to 90 wt %, greater than or equal to 50 wt % and less than or equal to 90 wt %, greater than or equal to 60 wt % and less than or equal to 90 wt %, greater than or equal to 65 wt % and less than or equal to 90 wt %, greater than or equal to 30 wt % and less than or equal to 80 wt %, greater than or equal to 40 wt % and less than or equal to 80 wt %, greater than or equal to 50 wt % and less than or equal to 80 wt %, greater than or equal to 60 wt % and less than or equal to 80 wt %, greater than or equal to 65 wt % and less than or equal to 80 wt %, greater than or equal to 30 wt % and less than or equal to 75 wt %, greater than or equal to 40 wt % and less than or equal to 75 wt %, greater than or equal to 50 wt % and less than or equal to 75 wt %, greater than or equal to 60 wt % and less than or equal to 75 wt %, greater than or equal to 65 wt % and less than or equal to 75 wt %, greater than or equal to 30 wt % and less than or equal to 70 wt %, greater than or equal to 40 wt % and less than or equal to 70 wt %, greater than or equal to 50 wt % and less than or equal to 70 wt %, greater than or equal to 60 wt % and less than or equal to 70 wt %, or greater than or equal to 65 wt % and less than or equal to 70 wt %. It should be understood that the above ranges include all subranges within the explicitly disclosed ranges.

In embodiments, the etchant used in the methods disclosed herein may comprise NaOH in an amount less than or equal to 10 wt %, less than or equal to 8 wt %, less than or equal to 6 wt %, less than or equal to 4 wt %, less than or equal to 2 wt %, less than or equal to 1 wt %, less than or equal to 0.5 wt %, or less than or equal to 0.1 wt %. In embodiments, the aluminosilicate glass-based article may not include NaOH. In embodiments, the aluminosilicate glass-based article may be substantially free of NaOH. Without intending to be bound by any particular theory, it is believed that some crystal phases, such as lithium disilicate (LS2), may preferentially etch faster than other crystal phases when etched with NaOH, resulting in increased surface roughness (Sq) of the treated glass-based article. It is believed that the exchange of lithium ions in the aluminosilicate glass-based article with sodium ions in an etchant comprising NaOH may accelerate the crystal dissolution. This phenomenon is depicted in FIG. 1B.

In FIG. 1B, the following reactions during aqueous hydroxide etching are depicted:

$$2 {H}_{2} O + {SiO}_{2} ( glass ) \to {Si ( OH )}_{4} ( glass ) \qquad ( Equation 1.1 )$$

$$2 {OH}^{-} + {Si ( OH )}_{4} ( glass ) \to {Si ( OH )}_{6}^{2 -} \qquad ( Equation 1.2 )$$

In FIG. 1B, the following reactions during fast-etch crystal dissolution are depicted:

$${Na}^{+} ( solution ) + {Li}^{+} ( glass ) \to {Na}^{+} ( glass ) + {Li}^{+} ( solution ) \qquad ( Equation 2.1 )$$

$$2 {Na}^{+} ( glass ) + {Li}_{2} {Si}_{2} {O}_{5} ( crystal ) \to {Na}_{2} {Si}_{2} {O}_{5} ( amorphous ) + 2 {Li}^{+} \qquad ( Equation 2.2 )$$

$${Na}_{2} {Si}_{2} {O}_{5} ( amorphous ) + 2 NaOH + 5 {H}_{2} O \to 4 {Na}^{+} + 2 {{Si ( OH )}_{6}}^{2 -} \qquad ( Equation 2.3 )$$

It is believed that the reduction of NaOH in the etchant, such as in the embodiments described herein, may decrease the surface roughness (Sq) of the surface of the aluminosilicate glass-based article.

In embodiments, the etchant used in the methods disclosed herein may comprise sodium ions in an amount less than or equal to 10 wt %, less than or equal to 8 wt %, less than or equal to 6 wt %, less than or equal to 4 wt %, less than or equal to 2 wt %, less than or equal to 1 wt %, less than or equal to 0.5 wt %, or less than or equal to 0.1 wt %. In embodiments, the aluminosilicate glass-based article may not include sodium ions. In embodiments, the aluminosilicate glass-based article may be substantially free of sodium ions.

In embodiments, the etchant may comprise a secondary salt. The secondary salt may not comprise sodium. The secondary salt may be a non-reactive component or a reactive component. As used herein, “non-reactive component” refers to a component etches the aluminosilicate glass-based article, and “reactive component” refers to a component that does not etch the aluminosilicate glass-based article. Non-limiting examples of the non-reactive components may include KNO₃, K₂SO₄, K₂CO₃, or K₃PO₄. Non-limiting examples of the reactive components may include Ca(OH)₂ or other hydroxide salts that do not include sodium. Without intending to be bound by any particular, it is believed that the addition of a secondary salt may reduce a melting temperature of the etchant, which may allow for etching the aluminosilicate glass-based article in an etchant comprising KOH, such as a molten and/or submolten mixture comprising KOH and a secondary salt. In embodiments, the secondary salt may comprise comprises potassium nitrate, potassium sulphate, potassium carbonate, potassium phosphate, calcium hydroxide, or combinations thereof.

The secondary salt may be present in the etchant in an amount greater than or equal to 0 wt % to less than or equal to 70 wt %, greater than or equal to 10 wt % to less than or equal to 70 wt %, greater than or equal to 20 wt % to less than or equal to 70 wt %, greater than or equal to 30 wt % to less than or equal to 70 wt %, greater than or equal to 40 wt % to less than or equal to 70 wt %, greater than or equal to 0 wt % to less than or equal to 60 wt %, greater than or equal to 10 wt % to less than or equal to 60 wt %, greater than or equal to 20 wt % to less than or equal to 60 wt %, greater than or equal to 30 wt % to less than or equal to 60 wt %, greater than or equal to 40 wt % to less than or equal to 60 wt %, greater than or equal to 0 wt % to less than or equal to 50 wt %, greater than or equal to 10 wt % to less than or equal to 50 wt %, greater than or equal to 20 wt % to less than or equal to 50 wt %, greater than or equal to 30 wt % to less than or equal to 50 wt %, or greater than or equal to 40 wt % to less than or equal to 50 wt %. It should be understood that the above ranges include all subranges within the explicitly disclosed ranges.

In embodiments, the etchant may comprise a solvent. In embodiments, the solvent, if present, is water. In embodiments, the etchant may comprise the solvent in an amount greater than or equal to 0 wt % and less than or equal to 70 wt %, greater than or equal to 10 wt % and less than or equal to 70 wt %, greater than or equal to 20 wt % and less than or equal to 70 wt %, greater than or equal to 30 wt % and less than or equal to 70 wt %, greater than or equal to 40 wt % and less than or equal to 70 wt %, greater than or equal to 50 wt % and less than or equal to 70 wt %, greater than or equal to 0 wt % and less than or equal to 60 wt %, greater than or equal to 10 wt % and less than or equal to 60 wt %, greater than or equal to 20 wt % and less than or equal to 60 wt %, greater than or equal to 30 wt % and less than or equal to 60 wt %, greater than or equal to 40 wt % and less than or equal to 60 wt %, greater than or equal to 50 wt % and less than or equal to 60 wt %, greater than or equal to 0 wt % and less than or equal to 50 wt %, greater than or equal to 10 wt % and less than or equal to 50 wt %, greater than or equal to 20 wt % and less than or equal to 50 wt %, greater than or equal to 30 wt % and less than or equal to 50 wt %, greater than or equal to 40 wt % and less than or equal to 50 wt %, equal to 0 wt % and less than or equal to 40 wt %, greater than or equal to 10 wt % and less than or equal to 40 wt %, greater than or equal to 20 wt % and less than or equal to 40 wt %, greater than or equal to 30 wt % and less than or equal to 40 wt %, or any and all sub-ranges formed from any of these endpoints. Without intending to be bound by any particular theory, it is believed that an etchant comprising a solvent, such as water, may dissolve the KOH in the etchant, thereby etching the aluminosilicate glass-based article in an aqueous solution in the methods described here. In embodiments, the etchant may comprise less than or equal to 15 wt. % water, less than or equal to 10 wt. % water, less than or equal to 5 wt. % water, or less than or equal to 1 wt. % water. In embodiments, the etchant may not include water or may be substantially free of water. In embodiments, the etchant may not include, or may be substantial free of, water not present in one or more salts used to form the etchant. For instance, in embodiments, the etchant may not include water intentionally added to the etchant, but may include water present in the salt used to form the etchant. Without intending to be bound by any particular theory, it is believed that water in the etchant may increase crystal dissolution of the aluminosilicate glass-based article, which may increase a surface roughness (Sq) of the surface of the treated glass-based article. In embodiments, the etchant may comprise an amount of water present in one or more salts used to form etchant.

The methods disclosed herein may include contacting the aluminosilicate glass-based article with the etchant under various etching conditions.

In embodiments, a temperature of the etchant during the contacting may be greater than or equal to 130° C., greater than or equal to 150° C., greater than or equal to 175° C., greater than or equal to 200° C., or even greater than or equal to 225° C. In embodiments, a temperature of the etchant during the contacting may be less than or equal to 300° C., less than or equal to 275° C., less than or equal to 250° C., less than or equal to 275° C., or less than or equal to 200° C. Without intending to be bound by any particular theory, it is believed that in embodiments where the etchant does not include a solvent, the temperature of the etchant should be greater than a melting temperature of the etchant.

In embodiments, the contacting may comprise submerging the aluminosilicate glass-based article in the etchant for a duration of time. In embodiments, the duration of time may greater than or equal to 5 minutes and less than or equal to 10 hours, less than or equal to 8 hours, less than or equal to 6 hours, less than or equal to 4 hours, or even less than or equal to 2 hours.

In particular embodiments, the etchant may comprise greater than or equal to 40 wt % and less than or equal to 80 wt % potassium hydroxide, greater than or equal to 20 wt % and less than or equal to 60 wt % of a secondary salt comprising potassium nitrate, potassium sulphate, potassium carbonate, potassium phosphate, or combinations thereof, and a temperature of the etchant during the contacting may be greater than or equal 200° C. and less than or equal to 300° C. In such embodiments, the etchant may be considered to be a molten and/or submolten etchant. As used herein, the term “submolten” may refer to a mixture of a molten salt and water present in the salt prior to heating.

In particular embodiments, the etchant may comprise greater than or equal to 60 wt % and less than or equal to 80 wt % potassium hydroxide, greater than or equal to 20 wt % and less than or equal to 40 wt % of water, and a temperature of the etchant may be greater than or equal 150° C. and less than or equal to 200° C. In such embodiments. The etchant may be considered an aqueous hydroxide etchant.

In embodiments, the contacting of the aluminosilicate glass-based article with the etchant reduces a thickness of the aluminosilicate glass-based article, thereby forming the treated glass-based article. In embodiments, the contacting may reduce the thickness of the aluminosilicate glass-based article by at least 1 μm, at least 3 μm, at least 5 μm, at least 10 μm, or even at least at least 20 μm at an average rate of greater than or equal to 1 μm per hour and less than or equal to 50 μm per hour, greater than or equal to 1 μm per hour and less than or equal to 25 μm per hour, greater than or equal to 1 μm per hour and less than or equal to 15 μm per hour, greater than or equal to 1 μm per hour and less than or equal to 10 μm per hour, greater than or equal to 5 μm per hour and less than or equal to 50 μm per hour, greater than or equal to 5 μm per hour and less than or equal to 25 μm per hour, greater than or equal to 5 μm per hour and less than or equal to 15 μm per hour, greater than or equal to 5 μm per hour and less than or equal to 10 μm per hour, greater than or equal to 10 μm per hour and less than or equal to 50 μm per hour, greater than or equal to 10 μm per hour and less than or equal to 25 μm per hour, greater than or equal to 10 μm per hour and less than or equal to 15 μm per hour, or any and all sub-ranges formed from any of these endpoints.

In embodiments, the aluminosilicate glass-based article may be treated by methods known in the art prior to the contacting. For instance, in embodiments, the method may comprise ion-exchanging the aluminosilicate glass-based article prior to the contacting.

In embodiments, the method may comprise ion-exchanging the treated glass-based article subsequent to the contacting. In such embodiments, the method may comprise contacting the treated glass-based article subsequent to the ion-exchanging with the etchant in a second contacting step.

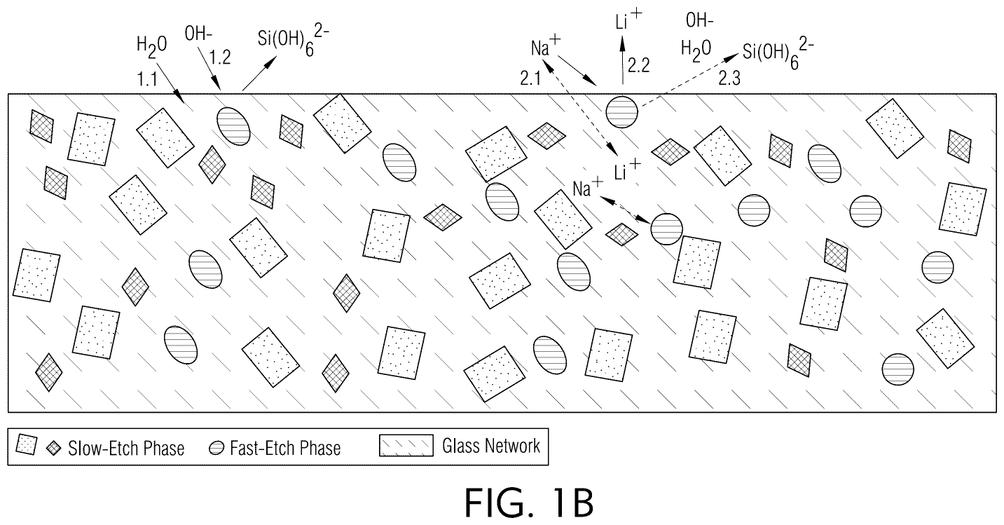

In embodiments, the etchant may be in a vessel prior to the contacting, during the contacting, and/or subsequent the contacting. Referring now to FIG. 2, a vessel 202, the aluminosilicate glass-based article 204, and the etchant 206 are depicted. In embodiments, the aluminosilicate glass-based article 204 and the etchant 206 may be positioned within the vessel 206 during the contacting. The vessel 202 may comprise vessel walls 208, wherein, in embodiments, the vessel walls 208 may comprise greater than or equal to 50 wt. % nickel, based on the total weight of the vessel walls 208. Higher temperatures and higher hydroxide contents of the etchant may be beneficial to improve an etching rate of the aluminosilicate glass-based article. However, these highly corrosive conditions may require vessels that maintain integrity during normal use and minimize the introduction of dissolved metal from the vessel into the etchant. Without intending to be bound by any particular theory, it is believed that the vessel walls comprising an increased amount of nickel may resist or reduce a corrosion rate of the vessel walls when contacting the etchant. Further, it is believed that these vessel walls comprising an increased amount of nickel may form a corrosion-resistant nickel oxide layer on the surface of the vessel walls. In embodiments, the vessel walls may comprise less than or equal to 100 wt. % nickel and greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or even greater than or equal to 99 wt. % nickel, based on the total weight of the vessel walls.

The method of forming the treated glass-based article may further comprise, after contacting the aluminosilicate glass-based article with the etchant, contacting the aluminosilicate glass-based article with an acid mixture. In embodiments, the acid mixture may comprise greater than or equal to 1 wt % and less than or equal to 20 wt % of one or more acids. Without intending to be bound by any particular theory, it is believed that a residue may form on the aluminosilicate glass-based article after contacting the aluminosilicate glass-based article with the etchant. Standard glass cleaning detergents may be less effective in removing the residue. It is believed that contacting the aluminosilicate glass-based article with the acid mixture may provide efficient processing and/or cleaning of the aluminosilicate glass-based article. In embodiments, the acid mixture may comprise greater than or equal to 1 wt. % of one or more acids, and less than or equal to 20 wt. %, less than or equal to 15 wt. %, less than or equal to 10 wt. %, less than or equal to 9 wt. %, less than or equal to 8 wt. %, less than or equal to 7 wt. %, or less than or equal to 6 wt. % of the one or more acids.

In embodiments, the acid mixture may comprise, consist of, or consist essentially of citric acid, hydrochloric acid, nitric acid, sulfuric acid, or combinations thereof. Contacting the aluminosilicate glass-based article with the acid mixture may comprise submerging the aluminosilicate glass-based article in the acid mixture. In embodiments, the aluminosilicate glass-based article may be submerged in the acid mixture for a duration of at least one minute, such as a duration of greater than or equal to 1 minute and less than or equal to 20 minutes. In embodiments, a temperature of the acid mixture during the contacting may be at least room temperature, such as greater than or equal to 18° C. In embodiments, the temperature of the acid mixture during the contacting may be greater than or equal to 18° C. and less than or equal to 80° C., less than or equal to 70° C., less than or equal to 60° C., or less than or equal to 50° C.

In embodiments, contacting the aluminosilicate glass-based article with the acid mixture may comprise stirring the acid mixture and/or ultrasonic agitation of the acid mixture.

The treated glass-based articles formed by the methods described herein may be characterized.

In embodiments, the treated glass-based article may comprise a surface, wherein a surface roughness (Sq) of the surface is less than or equal to 10 nm, less than or equal to 9 nm, less than or equal to 8 nm, less than or equal to 7 nm, less than or equal to 6 nm, or even less than or equal to 5 nm.

In embodiments, the treated glass-based article may be transparent, having an opacity of greater than or equal to 0% and less than or equal to 15%. In embodiments, the treated glass-based article may be translucent, having an opacity of greater than or equal to 15% and less than 80%. In embodiments, the treated glass-based article may be opaque, having an opacity of greater than 30% and less than 80%. In embodiments, the treated glass-based article may be opaque, having an opacity of greater than or equal to 80% and less than or equal to 100%.

In embodiments where the treated glass-based article is transparent, a transmittance haze of the surface of the treated glass-based article may be less than or equal to 1%, less than or equal to 0.9%, less than or equal to 0.8%, less than or equal to 0.7%, less than or equal to 0.6%, or even less than or equal to 0.5%. Transmittance haze may be measured according to ASTM D1003.

In particular embodiments, the surface of the treated glass-based article may comprise a transmittance haze less than or equal to 1% and an opacity less than or equal to 20%.

In particular embodiments, the surface may comprise a gloss of greater than or equal to 80% and an opacity of greater than or equal to 80%.

In embodiments, a gloss of the surface of the treated glass-based article may be greater than or equal to 80%.

In embodiments, the surface of the treated glass-based article may be a first major surface and the treated glass-based article further a second major surface, the first major surface opposite the second major surface. In embodiments, at least a portion of the first major surface may be textured. Without limitation, suitable techniques for texturing glass-based articles described herein are disclosed in U.S. patent application Ser. No. 18/443,962 and U.S. Provisional Patent Application No. 63/613,150, both of which are incorporated by reference in their entireties. In other embodiments, the surface of the treated glass-based article may not be textured. The treated glass-based article may comprise a plurality of surface features extending to a first depth from the first major surface towards the second major surface. In embodiments, the first depth is greater than or equal to 4 nm and less than or equal to 40 nm.

The treated glass-based article may comprise any combination oxide compositions disclosed in reference to the aluminosilicate glass-based articles described herein.

### Examples

In order that various embodiments be more readily understood, reference is made to the following examples, which illustrate various embodiments of the methods of forming the treated glass-based articles and the etchants described herein.

The composition of the aluminosilicate glass-based article treated as described below is shown in Table 1. Note that reference to “Glass-based Article A” refers to a glass-based article that has the respective composition shown in Table 1 prior to any treatment with the various etchants.

TABLE 1

| Glass-Based Article A | wt. % |
|---|---|
| SiO₂ | 72.3 |
| Al₂O₃ | 7.2 |
| P₂O₅ | 2.5 |
| Li₂O | 11.6 |
| Na₂O | 0.07 |
| K₂O | 0.12 |
| ZrO₂ | 5.97 |
| Fe₂CO₃ | 0.06 |
| CaO | 0.7 |

Table 2 shows the composition of Example Etchants A-H and Comparative Etchants I-K (in wt %).

TABLE 2

| Etchant | KOH | KNO₃ | Water | NaOH | K₃PO₄ | K₂CO₃ | Ca(OH)₂ |
|---|---|---|---|---|---|---|---|
| Example | 63.75 | 25 | 11.25 | — | — | — | — |
| Etchant A | | | | | | | |
| Example | 51 | 40 | 9 | — | — | — | — |
| Etchant B | | | | | | | |
| Example | 42.5 | 50 | 7.5 | — | — | — | — |
| Etchant C | | | | | | | |
| Example | 59.5 | — | 40.5 | — | — | — | — |
| Etchant D | | | | | | | |
| Example | 59.5 | — | 40.5 | — | 2 | — | — |
| Etchant E | | | | | | | |
| Example | 59.5 | — | 40.5 | — | — | 2 | — |
| Etchant F | | | | | | | |
| Example | 59.5 | — | 40.5 | — | — | — | 2 |
| Etchant G | | | | | | | |
| Example | 59.5 | — | 40.5 | — | — | — | 5 |
| Etchant H | | | | | | | |
| Comparative | — | — | 50 | 50 | — | — | — |
| Etchant I | | | | | | | |
| Comparative | — | — | 30 | 70 | — | — | — |
| Etchant J | | | | | | | |
| Comparative | 48.45 | — | 8.55 | 43 | — | — | — |
| Etchant K | | | | | | | |

In the Examples that follow, Glass-based Article A was treated under various conditions. Unless stated otherwise, the Glass-based Article A of each Example was treated as follows prior to the etching as described in the Examples. Glass-based Article A was cut to 50 mm×50 mm size. Thereafter Glass-based Article A was cleaned in an aqueous solution, followed by rinsing and drying. In the Examples that follow, the Glass-based Article A was subsequently treated by submerging the Glass-based Article A in each of the etchants described. The Glass-based Article A of each Example was submerged for a duration sufficient to remove 20 μm from a side of the Glass-based Article A. The etching conditions, single side etch rate, and estimated etch time of each Example are reported in Table 3. The treated glass-based articles were cleaned in an aqueous solution, rinsed, and dried prior to further characterization. Properties of the treated glass-based article, including the root mean square height (Sq) roughness, arithmetical mean height (Sa) roughness, transmittance haze, and haze reduction relative to Comparative Example 1 (Comparable Article I formed from Comparative Etchant I) are also reported in Table 3.

TABLE 3

| | | Single | | | | | |
|---|---|---|---|---|---|---|---|
| | | Side | | | | | Haze |
| | | etch | | | | | Reduction |
| | Etch | rate | Approximate | | | | compared to |
| | Temp. | (μm/ | etch time | Sq | Sa | | Comparative |
| Article | (° C.) | hour) | (min) | (μm) | (μm) | Haze | Example 1 |
| A-1 | 230 | 13 | 92.3 | 0.0048 | 0.0038 | 0.681 | 78% |
| A-2 | 240 | 22.2 | 54 | 0.0045 | 0.0036 | 0.79 | 75% |
| A-3 | 250 | 27 | 44.4 | 0.0055 | 0.0043 | 0.935 | 70% |
| B-1 | 230 | 11.2 | 107.1 | 0.0037 | 0.0029 | 0.61 | 81% |
| B-2 | 240 | 14.4 | 8.3 | 0.0037 | 0.0029 | 0.5 | 84% |
| B-3 | 250 | 25.8 | 46.5 | 0.0041 | 0.0032 | 0.51 | 84% |
| C-1 | 230 | 11.6 | 103.4 | 0.0032 | 0.0025 | 0.391 | 88% |
| C-2 | 240 | 17.5 | 68.6 | 0.0031 | 0.0024 | 0.396 | 87% |
| C-3 | 250 | 63.2 | 0.0032 | 0.0032 | 0.0025 | 0.396 | 87% |
| D-1 | 165 | 2.2 | 545.5 | 0.004 | 0.003 | 0.47 | 85% |
| D-2 | 180 | 3 | 400 | 0.005 | 0.004 | 0.85 | 73% |
| D-3 | 195 | 6.2 | 193.5 | 0.006 | 0.0046 | 1.05 | 67% |
| E | 165 | 2.5 | 480 | 0.007 | 0.005 | 1.33 | 58% |
| F | 165 | 2.2 | 545.5 | 0.006 | 0.005 | 1.32 | 58% |
| G | 165 | 1.9 | 631.6 | 0.011 | 0.009 | 2.44 | 23% |
| H | 185 | 6.8 | 177.5 | 0.0054 | 0.0039 | 0.64 | 79% |
| I | 130 | 3.6 | 333.3 | 0.014 | 0.012 | 3.15 | — |
| J | 165 | 16.3 | 73.6 | 0.011 | 0.009 | 2.30 | 27% |
| K | 220 | 50.24 | 23.9 | 0.010 | 0.008 | 2.23 | 29% |

### Example 1—Example Article A (Etchant A)

To obtain Etchant A, potassium hydroxide (KOH), 85% purity, and potassium nitrate (KNO₃) were mixed at a weight ratio of 3:1, heated to a temperature of at least 230° C., and stirred to form a submolten mixture. In the etchants described herein, the calculated compositions assume that the KOH salt used included 85% KOH and 15% water. For instance, as shown in Table 2, Etchant A includes 63.75 wt. % KOH and 11.25 wt. % water (from the KOH salt). The etchant was maintained at 230° C., 240° C., or 250° C. according to the Examples that follow.

Glass-based Article A was submerged in Etchant A at a temperature of 230° C., 240° C., 250° C., respectively, thereby forming Example Articles A-1, A-2, and A-3.

### Example 2—Example Article B (Etchant B)

Etchant B was obtained according to the procedure of forming Etchant A, with the exception that KOH (85% purity) and KNO₃ were mixed at a weight ratio of 3:2.

Glass-based Article A was submerged in Etchant B at a temperature of 230° C., 240° C., 250° C., respectively, thereby forming Example Articles B-1, B-2, and B-3.

### Example 3—Example Article C (Etchant C)

Etchant C was obtained according to the procedure of forming Etchant A, with the exception that KOH (85% purity) and KNO₃ were mixed at a weight ratio of 1:1.

Glass-based Article A was submerged in Etchant C at a temperature of 230° C., 240° C., 250° C., respectively, thereby forming Example Article C-1, C-2, and C-3.

### Example 4—Example Article D (Etchant D)

To obtain Etchant D, KOH (85% purity) and water were mixed at a weight ratio of 7:3. The mixture was heated and stirred to dissolve the KOH. As discussed here in in reference to the purity of the KOH salt, the KOH salt is assumed to include 85% KOH and 15% water. Thus, Etchant D includes both water present in the KOH salt (10.5 wt %) and additional water added (30 wt %).

Glass-based Article A was submerged in Etchant D at a temperature of 165° C., 180° C., and 195° C., respectively, thereby forming Example Article D-1, D-2, and D-3.

### Example 5—Example Article E (Etchant E)

To obtain Etchant E, KOH (85% purity), tripotassium phosphate (K₃PO₄), and water were mixed at a weight ratio of 70:2:28. The mixture was heated and stirred to dissolve the KOH and K₃PO₄.

Glass-based Article A was submerged in Etchant E at a temperature of 165° C., thereby forming Example Article E.

### Example 6—Example Article F (Etchant F)

To obtain Etchant F, KOH (85% purity), potassium carbonate (K₂CO₃), and water were mixed at a weight ratio of 70:2:28. The mixture was heated and stirred to dissolve the KOH and K₂CO₃.

Glass-based Article A was submerged in Etchant F at a temperature of 165° C., thereby forming Example Article F.

### Example 7—Example Article G (Etchant G)

To obtain Etchant G, KOH (85% purity), calcium hydroxide (Ca(OH)₂), and water were mixed at a weight ratio of 70:2:28. The mixture was heated and stirred to dissolve the KOH and Ca(OH)₂.

Glass-based Article A was submerged in Etchant G at a temperature of 165° C., thereby forming Example Article G.

### Example 8—Example Article H (Etchant H)

Etchant H was obtained according to the procedure of forming Etchant G, with the exception that KOH (85% purity), Ca(OH)₂, and water were mixed at a weight ratio of 70:5:25.

Glass-based Article A was submerged in Etchant H at a temperature of 185° C., thereby forming Example Article H.

### Comparative Example 1—Comparative Article I (Etchant I)

To obtain Etchant I, sodium hydroxide (NaOH) and water were mixed at a weight ratio of 1:1. The mixture was heated and stirred to dissolve the NaOH.

Glass-based Article A was submerged in Etchant I at a temperature of 130° C., thereby forming Comparative Example Article I.

### Comparative Example 2—Comparative Article J (Etchant J)

Etchant J was obtained according to the procedure of forming Etchant I, with the exception that NaOH and water were mixed at a weight ratio of 7:3.

Glass-based Article A was submerged in Etchant J at a temperature of 165° C., thereby forming Comparative Example Article J.

### Comparative Example 3—Comparative Article K (Etchant K)

To obtain Etchant K, KOH (85% purity) and NaOH were mixed at a weight ratio of 57:43, heated to a temperature of at least 190° C., and stirred to form a submolten mixture.

Glass-based Article A was submerged in Etchant K at a temperature of 220° C., thereby forming Comparative Example Article K.

### Example 9—Analysis of Example Articles and Comparative Articles of Examples 1-8

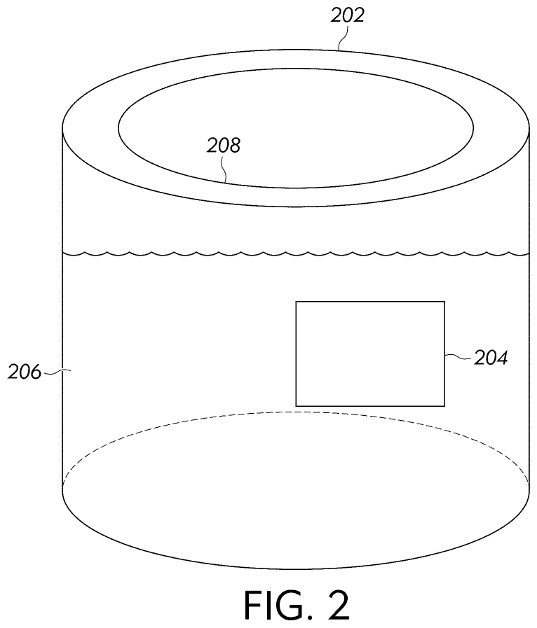

As shown in Table 3, methods using an etchant comprising greater than 30 wt % KOH and in the absence of NaOH resulted in forming treated glass-based articles having a reduced surface roughness (Sq) compared to the comparative etchants comprising greater than 10 wt % NaOH. Further, the haze of treated aluminosilicate glass-based articles according to the methods described herein was significantly reduced compared to the conventional etchant comprising 50 wt. % NaOH. A plot of the haze (y-axis) as a function of Sq (x-axis) of a selection of Examples Articles and Comparative Articles is shown in FIG. 3. As shown in FIG. 3, the Example Articles had an Sq of less than 10 nm and the Comparative Articles had an Sq of greater than or equal to 10 nm. Further, the Example Articles had a haze of less than 2% and the Comparative Articles had a haze of greater than 2%.

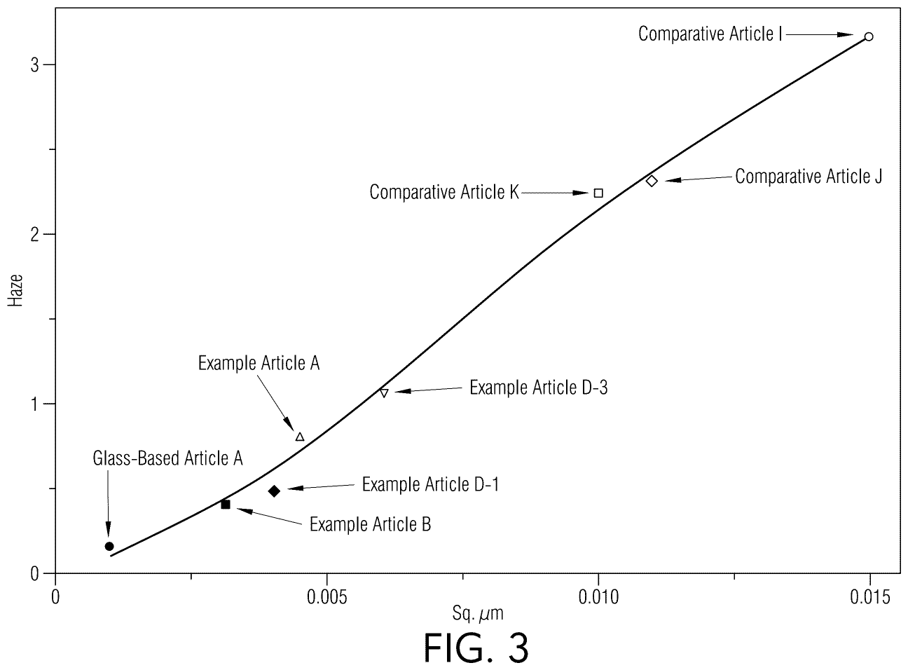

The surfaces of Comparative Article J (70 wt. % NaOH at 130° C.) and Example Articles D-3 (59.5 wt % KOH in water at 195° C.), D-2 (59.5 wt % KOH in water at 180° C.), and A-1 (submolten 63.75 wt % KOH/25% KNO₃ at 230° C.) were analyzed using scanning electron microscopy (SEM), as shown in FIG. 4. As shown in FIG. 4, the surface of Comparative Article J has a more granular appearance compared the surfaces of Example Articles D-3, D-2, and A-1. It is believed that greater differential etching of the aluminosilicate glass-based article occurred using the comparative etchant comprising NaOH compared to the methods using KOH.

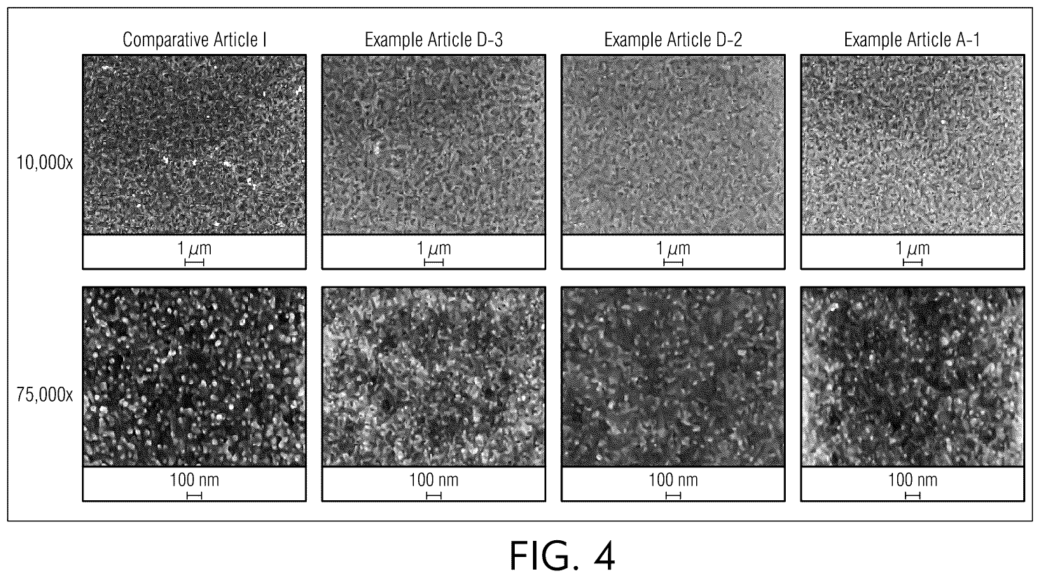

Surface strengths of Comparative Article J (70 wt. % NaOH at 130° C.) and Example Article D-1 (59.5 wt % KOH in water at 165° C.) were evaluated using ring-on-ring testing according to ASTM C1499. A surface strength of a control (aluminosilicate glass-based article prior to etching) was also measured. A plot of the ring-on-ring test is shown in FIG. 5. As shown in FIG. 5, the Example article that was etched with an etchant comprising 59.5 wt % KOH demonstrated increased surface strength compared to the comparative article that was etched with 70 wt % NaOH.

### Example 10—Repolishing of Glass-Based Articles Using Etchant D

In Example 10, the Glass-based Article A was ion exchanged in a molten bath comprising 19.9 wt. % KNO₃, 79.9 wt. % NaNO₃, and 0.2 wt. % LiNO₃, preloaded with 0.3% trisodium phosphate at 530° C. for 3.5 hours. The ion-exchanged Glass-based Article A was then subsequently treated with Etchant of Example 4. The ion-exchanged Glass-based Article A was submerged in Etchant D at a temperature of 165° C. a for a duration sufficient to remove 1 μm, 3 μm, and 5 μm from a side of the ion-exchanged Glass-based Article A, thereby forming Example Articles 10-1, 10-2, and 10-3, respectively. The Sq, Sa, and haze of the Example Articles 10-1, 10-2, 10-3, and the ion-exchanged Glass-based Article A prior to treatment (labeled “Control”) are reported in Table 4.

TABLE 4

| | Etch | Single Side | | | |
|---|---|---|---|---|---|
| | Temp. | etch amount | Sq | Sa | |
| Article | (° C.) | (μm) | (μm) | (μm) | Haze |
| 10-1 | 165 | 1 | 0.0018 | 0.0014 | 0.35 |
| 10-2 | 165 | 3 | 0.0019 | 0.0015 | 0.267 |
| 10-3 | 165 | 5 | 0.0026 | 0.0017 | 0.289 |
| Control | — | — | 0.0009 | 0.0007 | 0.152 |

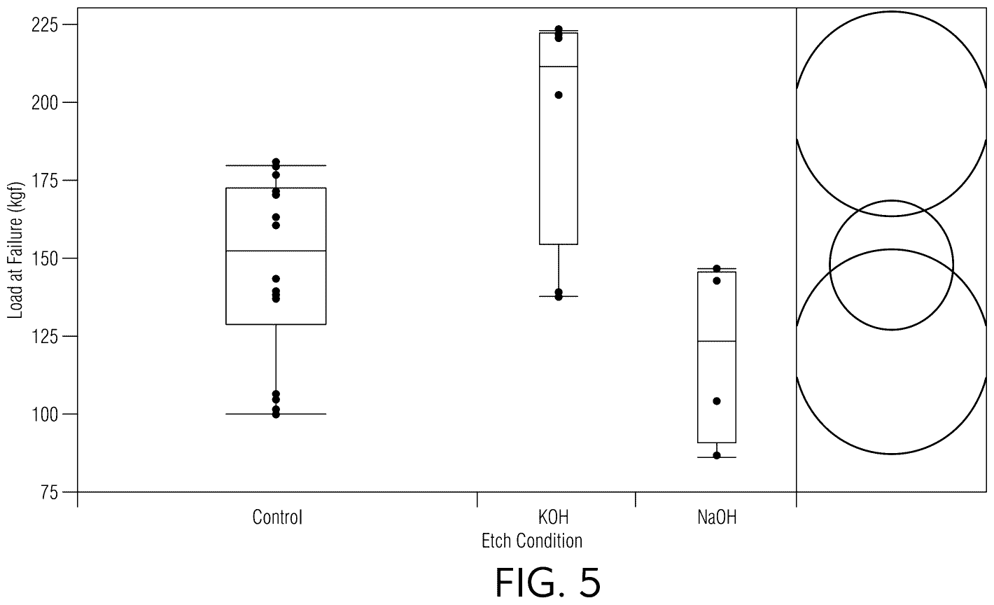

As shown in Table 4, subsequent to ion-exchanging the aluminosilicate glass-based article, a thickness of the resulting substrate was reduced while maintaining a low surface roughness (Sq) of the treated glass-based articles. Further, the surface of the control and Example Article 10-2 were analyzed using electron microscopy. SEM images of the ion-exchanged aluminosilicate glass-based article prior to etching (a) and the treated glass-based article (b) are shown in FIG. 6. As shown in FIG. 6, precipitated particles are present on the surface of the control (after ion-exchange). Subsequent to etching the control with Etchant A, the surface of the treated glass-based article is free of the precipitated particles. FIG. 6 also shows a further magnified image of the control (c) and the Example Article (d).

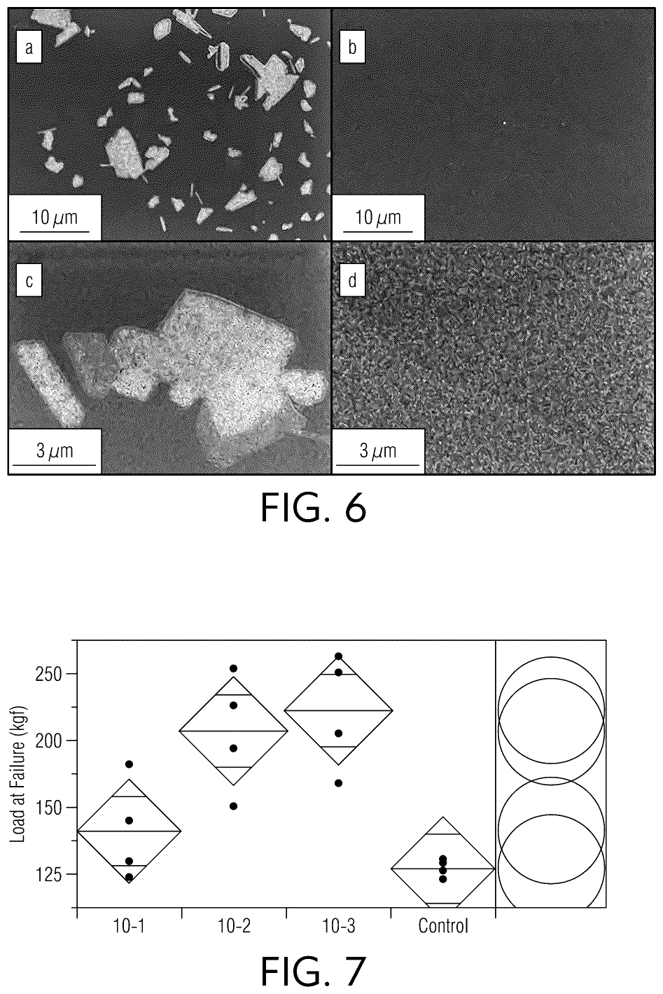

Surface strengths of Example Articles 10-1, 10-2, and 10-2 were evaluated using ring-on-ring testing according to ASTM C1499. A surface strength of a control (aluminosilicate glass-based article prior to etching) was also measured. A plot of the ring-on-ring test is shown in FIG. 7. As shown in FIG. 7, the Example article that was etched with an etchant comprising 59.5 wt % KOH demonstrated increased surface strength compared to the control.

### Example 11—Acid Washing the Aluminosilicate Glass-Based Article after Contacting with Etchant

In Example 11, the aluminosilicate-based glass article was washed in an acid solution after being submerged in Etchant A according to Example 1. Specifically, after submerging the the aluminosilicate-based glass article in the etchant, the aluminosilicate-based glass article was suspended in a solution of either 5 wt. % citric acid, or 5 wt. % HCl for a duration of 2 to 15 minutes. The aluminosilicate-based glass article was then removed from the acid solution, dipped in deionized water, and then dried with compressed air. This procedure resulted in complete removal of all visible residue on the aluminosilicate-based glass article. The haze of the aluminosilicate-based glass article before and after the acid washing, and the surface roughness (Sq and Sa) are reported below in Table 5. As a control for comparison, one sample of the aluminosilicate-based glass article was not washed with the acid solution but was washed manually with a cloth and isopropanol.

TABLE 5

| | | | | | | Surface |
|---|---|---|---|---|---|---|
| | Acid | | | | | roughness |
| | solution | Acid | Wash | Haze | Haze | after wash |
| | temperature | solution | time | before | after | (Sq, Sa) |
| Example | (° C.) | composition | (min) | wash | Wash | [nm] |
| 11-1 | 30 | 5 wt % | 2 | 6.73 | 0.37 | 2.8, 2.2 |
| | | Citric Acid | | | | |
| 11-2 | 30 | 5 wt % HCl | 2 | 8.58 | 0.36 | 2.9, 2.3 |
| 11-3 | 30 | 5 wt % | 15 | 9.35 | 0.35 | 2.9, 2.3 |
| | | Citric Acid | | | | |
| 11-4 | 30 | 5 wt % HCl | 15 | 6.92 | 0.34 | 2.8, 2.2 |
| Control | — | — | — | — | 0.396 | 3.2, 2.5 |

Successive washing of 8 samples of the aluminosilicate-based glass article were washed in the same 100 mL 5 wt % citric acid solution. The acid solution did no show a reduction in efficacy of the acid solution. A 5 mL aliquot of the acid solution at 4 separate intervals was measured using dynamic light scattering. The mass of the aluminosilicate-based glass article before and after the acid wash, calculated mass loss, and calculated cumulative residue concentration (mg/mL) are reported in Table 6. The acid solution did not show signs of having dissolved particles present according to the dynamic light scattering measurements.

TABLE 6

| | | Mass | Mass | | Acid | Cumulative |
|---|---|---|---|---|---|---|
| | | before | after | | solution | residue |
| Measurement | Sample | wash | wash | Mass | volume | concentration |
| # | # | (g) | (g) | loss (g) | (mL) | (mg/mL) |
| 1 | 0 | 0 | 0 | 0 | 100 | 0 |
| 2 | 1 | 3.4669 | 3.4658 | 0.0011 | 95 | 0.0168 |
| | 2 | 3.4734 | 3.4729 | 0.0005 | 95 | |
| 3 | 3 | 3.468 | 3.4674 | 0.0006 | 90 | 0.0357 |
| | 4 | 3.4631 | 3.462 | 0.0011 | 90 | |
| 4 | 5 | 3.4664 | 3.466 | 0.0004 | 85 | 0.0604 |
| | 6 | 3.4621 | 3.4614 | 0.0007 | 85 | |
| | 7 | 3.4639 | 3.4633 | 0.0006 | 85 | |
| | 8 | 3.4651 | 3.4647 | 0.0004 | 85 | |

### Example 12—Nickel Containing Etchant Vessel

In Example 12, the effects of contacting Etchant C on various materials was evaluated. Specifically, nickel alloys of Ni201 alloy (greater than or equal to 99 wt. % nickel) and Ni400 alloy (63-70% nickel) were evaluated and compared to stainless steel alloys SS301 (7% nickel) and SS904L (23-28% nickel). The various alloys were contacted with Etchant C at a temperature of 250° C. for a duration of 72 hours or 168 hours. The initial weight of the alloy, final weight of the alloy, weight loss (g), surface area (without edge sidewall), weight loss (g/m²), and corrosion rate (mm/year) are reported in Table 7.

TABLE 7

| | | Etch | Initial | Final | Surface | Weight | Corrosion |
|---|---|---|---|---|---|---|---|
| | Metal | time | weight | weight | area | Loss | Rate |
| Example | Alloy | (hr) | (g) | (g) | (m²) | (g; g/m²) | (mm/year) |
| 12-1 | Ni201 | 72 | 8.9198 | 8.9104 | 0.0013 | 0.0094; | 0.10 |
| | | | | | | 7.22 | |
| 12-2 | Ni201 | 168 | 8.9051 | 8.8889 | 0.0013 | 0.0164; | 0.08 |
| | | | | | | 12.54 | |
| 12-3 | Ni400 | 72 | 9.1305 | 9.1174 | 0.0013 | 0.0131; | 0.14 |
| | | | | | | 10.07 | |

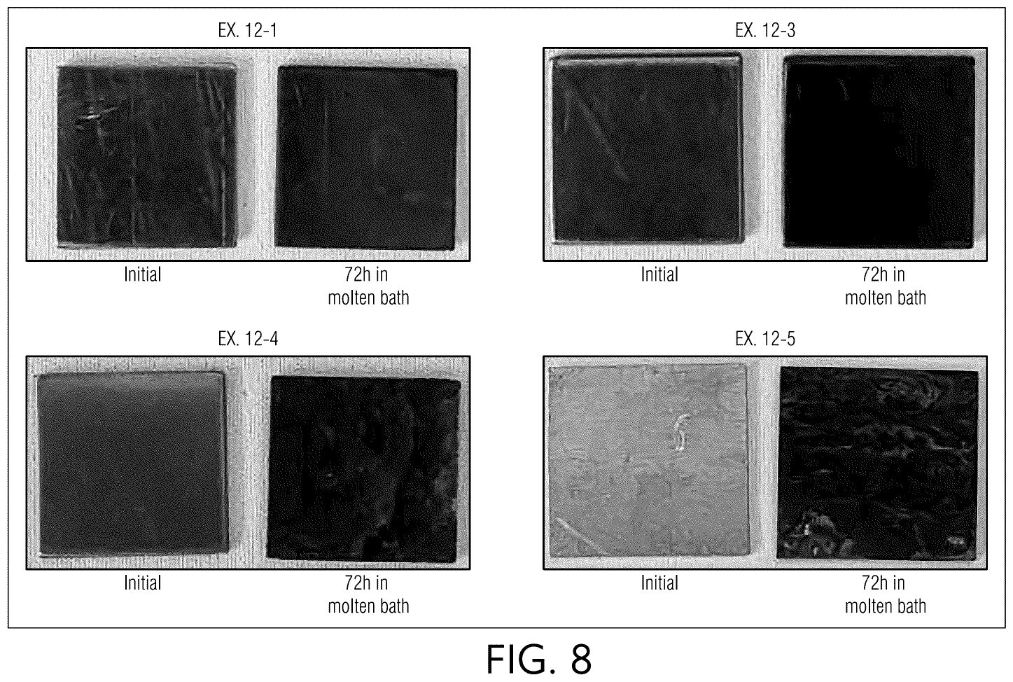

Stainless steel alloys SS301 (7% nickel) and SS904L (23-28% nickel) were contacted with Etchant C at a temperature of 250° C. for a duration of 72 hours, and are referred to as Examples 12-4 and 12-5. Images of the alloy of Example 12-1, 12-3, 12-4, and 12-5 before and after contacting the etchant for 72 hours are shown in FIG. 8. As shown in FIG. 8, contacting the nickel alloys of Examples 12-1 and 12-3 with Etchant C resulted in slight darkening of the alloys. In contrast, contacting the stainless steel alloys of Examples 12-4 and 12-5 resulted in significant darken and a visibly corroded surface with a rough surface morphology.

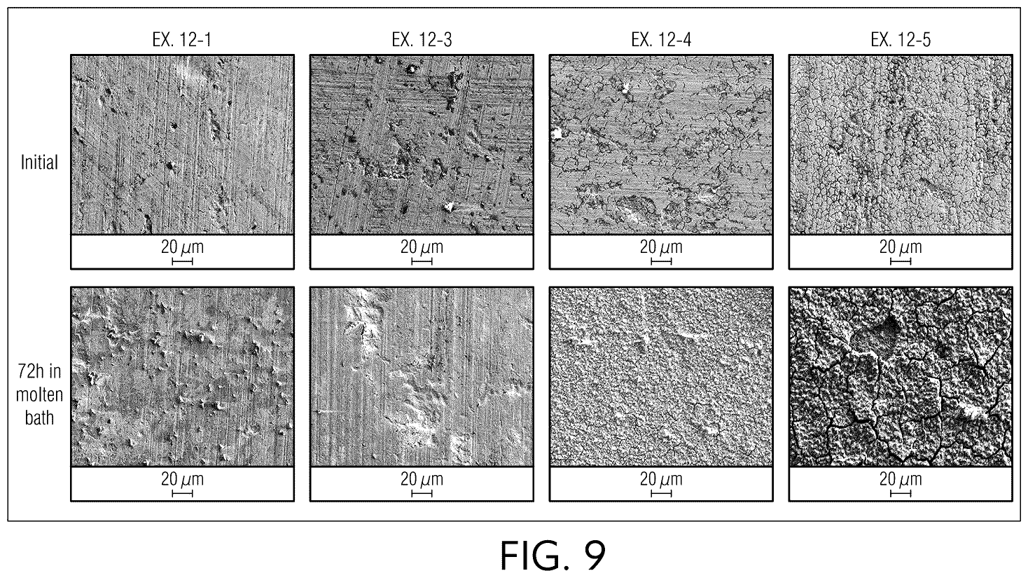

The surface of Examples 12-1, 12-3, 12-4, and 12-5 were also evaluated using scanning electron microscopy (SEM) to image the alloy before and after contacting the etchant for 72 hours, as shown in FIG. 9. The SEM images of the stainless steel alloys of Examples 12-4 and 12-5 demonstrate significant changes on the surface after treatment, which includes oxide spallation. The SEM images of the nickel alloys of Examples 12-1 and 12-3 did not demonstrate significant changes on the surface after treatment.

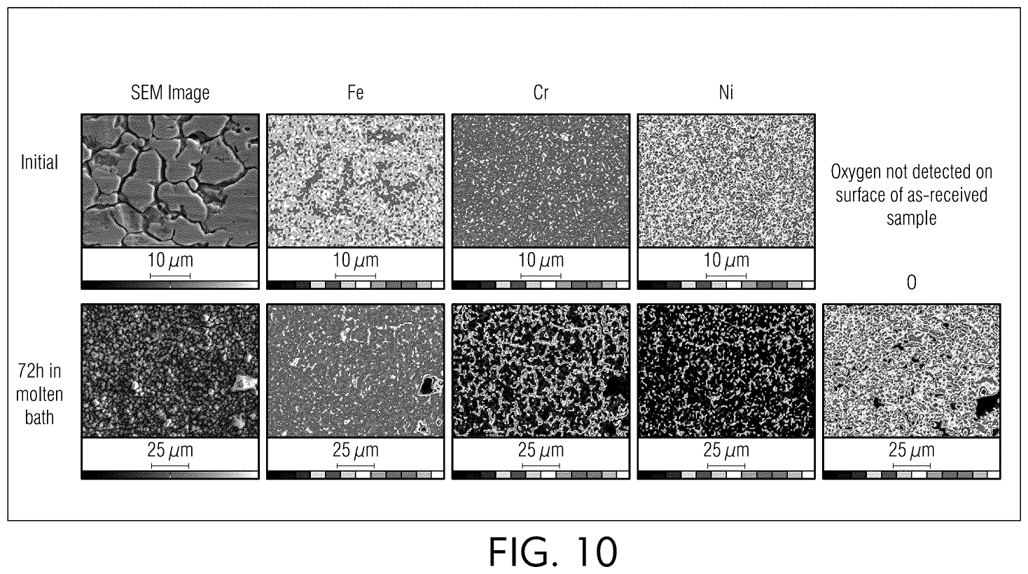

The surface of Example 12-4 was further evaluated using scanning electron microscopy-energy dispersive X-ray analysis (SEM-EDX), which is shown in FIG. 10. As shown in FIG. 10, the initial SS301 alloy contained significant concentrations of Fe, Cr and Ni, without oxygen. After contacting the etchant, the alloy had an Fe—O rich layer, with minor concentrations of Cr and Ni.

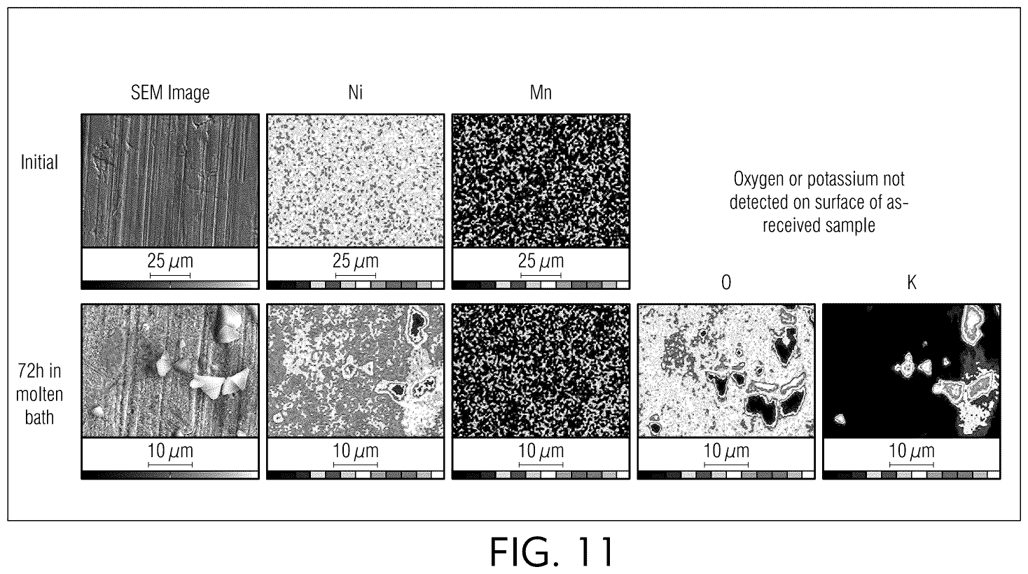

The surface of Example 12-1 was further evaluated using SEM-EDX, which is shown in FIG. 11. As shown in FIG. 11, the initial Ni201 alloy contained significant concentrations of Ni, without oxygen, and minor concentrations of Mn. After contacting the etchant, the alloy had a Ni—O rich layer, with minor concentrations of Mn. Certain portions of the alloy also included residual K salt from the etchant, depicted by high K signal, low Ni signal, and low O signal.

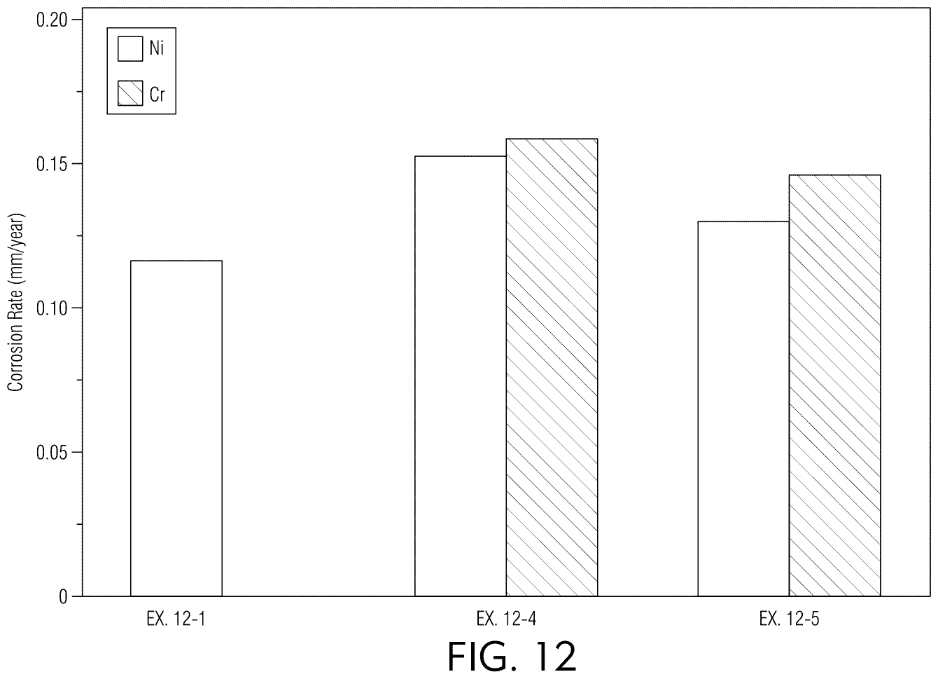

The corrosion rate of the alloys of Examples 12-1, 12-4, and 12-5 were estimated by measuring the change in concentration of nickel and/or chromium in the etchant after contacting the alloy in the etchant for 72 hours, normalized according to the amount of nickel and chromium in each alloy. The results of the calculated corrosion rates are shown in FIG. 12. As shown in FIG. 12, the corrosion rate of Example 12-1 was less than the corrosion rate of Examples 12-4 and 12-5.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of forming a treated glass-based article, wherein the method comprises:
contacting an aluminosilicate glass-based article with an etchant, the etchant comprising:
greater than or equal to 30 wt % and less than or equal to 100 wt % potassium hydroxide; and
less than or equal to 10 wt % sodium hydroxide; and
wherein a temperature of the etchant is greater than or equal to 130° C. during the contacting.

2. The method of claim 1, wherein the etchant comprises less than or equal to 10 wt % sodium ions.

3. The method of claim 1, wherein the etchant comprises less than or equal to 15 wt. % water.

4. The method of claim 1, wherein the etchant further comprises greater than 0 wt. % and less than or equal to 70 wt % of a secondary salt, wherein the secondary salt does not comprise sodium.

5. The method of claim 1, wherein:
the etchant comprises:
greater than or equal to 30 wt % and less than or equal to 80 wt % potassium hydroxide; and
greater than or equal to 20 wt % and less than or equal to 60 wt % of a secondary salt comprising potassium nitrate, potassium sulphate, potassium carbonate, potassium phosphate, or combinations thereof;
a temperature of the etchant is greater than or equal 200° C. and less than or equal to 300° C.; and
the contacting comprises submerging the aluminosilicate glass-based article in the etchant for a duration of time is greater than or equal to 5 minutes and less than or equal to 2 hours.

6. The method of claim 1, wherein:
the etchant comprises:
greater than or equal to 50 wt % and less than or equal to 70 wt % potassium hydroxide;
greater than or equal to 30 wt % and less than or equal to 50 wt % of water; and
a temperature of the etchant is greater than or equal 150° C. and less than or equal to 200° C.; and
the contacting comprises submerging the aluminosilicate glass-based article in the etchant for a duration of time is greater than or equal to 5 minutes and less than or equal to 2 hours.

7. The method of claim 1, wherein the etchant comprises greater than or equal to 30 wt % potassium hydroxide, and greater than or equal to 0 wt % and less than or equal to 70 wt % of a secondary salt comprising potassium nitrate, potassium sulphate, potassium carbonate, potassium phosphate, or combinations thereof.

8. The method of claim 1, wherein the treated glass-based article comprises a surface, and wherein a surface roughness (Sq) of the surface is less than or equal to 10 nm.

9. The method of claim 8, wherein the surface is a first major surface and the treated glass-based article comprises a second major surface, the first major surface opposite the second major surface, wherein at least a portion of the first major surface is textured.

10. The method of claim 1, wherein:
an opacity of the treated glass-based article is greater than or equal to 0% and less than or equal to 30%;
an opacity of the treated glass-based article is greater than 30% and less than 80%; or
an opacity of the treated glass-based article is greater than or equal to 80% and less than or equal to 100%.

11. The method of claim 1, wherein at least one of:
a transmittance haze of the surface is less than or equal to 1%;
a gloss of the surface is greater than or equal to 80%.

12. The method of claim 1, wherein the aluminosilicate glass-based article comprises a surface, and wherein at least a portion of the surface is textured.

13. The method of claim 1, wherein the aluminosilicate glass-based article comprises glass ceramic.

14. The method of claim 1, wherein the aluminosilicate glass-based article comprises:
greater than or equal to 55 wt % and less than or equal to 80 wt % SiO₂;
greater than or equal to 2 wt % and less than or equal to 12 wt % Al₂O₃;
greater than or equal to 8 wt % and less than or equal to 17 wt % Li₂O;
greater than or equal to 0.1 wt % and less than or equal to 5 wt % P₂O₅;
greater than or equal to 2 wt % and less than or equal to 15 wt % ZrO₂;
greater than or equal to 0.05 wt % and less than or equal to 4 wt % CaO;
greater than or equal to 0 wt % and less than or equal to 3 wt % MgO;
greater than or equal to 0 wt % and less than or equal to 4 wt % ZnO;
greater than or equal to 0 wt % and less than or equal to 5 wt % Na₂O;
greater than or equal to 0 wt % and less than or equal to 3 wt % K₂O; and
greater than or equal to 0 wt % and less than or equal to 2 wt % Fe₂O₃.

15. The method of claim 1, wherein the etchant is in a vessel during the contacting, and wherein the vessel comprises vessel walls, the vessel walls comprising greater than or equal to 50 wt. % nickel, based on the total weight of the of the vessel walls.

16. A glass-based article, the glass-based article comprising a first major surface and a second major surface, the first major surface opposite the second major surface,
wherein:
the treated glass-based article comprises a plurality of surface features extending to a first depth from the first major surface towards the second major surface;
the first depth is greater than or equal to 4 nm and less than or equal to 40 nm; and
a surface roughness (Sq) of the first major surface is less than or equal to 10 nm.

17. The glass-based article of claim 16, wherein the first major surface comprises:
a transmittance haze less than or equal to 1% and an opacity less than or equal to 20%; or
a gloss of greater than or equal to 80% and an opacity of greater than or equal to 80%.

18. The glass-based article of claim 16, comprising a glass ceramic.

19. The glass-based article of claim 16, comprising:
greater than or equal to 55 wt % and less than or equal to 80 wt % SiO₂;
greater than or equal to 2 wt % and less than or equal to 12 wt % Al₂O₃;
greater than or equal to 8 wt % and less than or equal to 17 wt % Li₂O;
greater than or equal to 0.1 wt % and less than or equal to 5 wt % P₂O₅;
greater than or equal to 2 wt % and less than or equal to 15 wt % ZrO₂;
greater than or equal to 0.05 wt % and less than or equal to 4 wt % CaO;
greater than or equal to 0 wt % and less than or equal to 3 wt % MgO;
greater than or equal to 0 wt % and less than or equal to 4 wt % ZnO;
greater than or equal to 0 wt % and less than or equal to 5 wt % Na₂O;
greater than or equal to 0 wt % and less than or equal to 3 wt % K₂O; and
greater than or equal to 0 wt % and less than or equal to 2 wt % Fe₂O₃.

20. A vessel for forming a treated glass-based article, wherein:
the vessel comprises vessel walls, the vessel walls comprising greater than or equal to 50 wt. % nickel, based on the total weight of the of the vessel walls;
an aluminosilicate glass-based article and an etchant are positioned within the vessel; a temperature of the etchant is greater than or equal to 130° C.; and
the etchant comprises:
greater than or equal to 30 wt % and less than or equal to 100 wt % potassium hydroxide; and
less than or equal to 10 wt % sodium hydroxide.
